(19) United States
(12) Patent Application Publication
(10) Pub. No.: US 2025/0013698 A1
(43) Pub. Date: Jan. 9, 2025

(54) SYSTEM AND METHOD

(71) Applicant: Paul Damian Nelson, Melbourne (AU)

(72) Inventor: Paul Damian Nelson, Melbourne (AU)

(21) Appl. No.: 18/750,836

(22) Filed: Jun. 21, 2024

(30) Foreign Application Priority Data
Jul. 9, 2023 (AU) 2023902201

(51) Int. Cl. G06F 16/953

(52) U.S. Cl. CPC G06F 16/953

(57) ABSTRACT

Systems and methods of inventions herein include computer implemented methods for providing added descriptive or relatable content in search engine databases, and presenting added descriptive or relatable content in knowledge panel search results. In one aspect of the invention there is a computer implemented method including one or more processors configured to perform operations including: a method of a top-level domain system comprising at least a term such as a search term connected via relationship with at least a part of search related material, where the term is a domain in a knowledge panel that is a fractal of the search. The domain can be applied to an entity of a knowledge panel via an auction or any other process.

### CROSS-REFERENCE TO RELATED APPLICATIONS

This application claims priority of the Australian Provisional application 2023902201 dated 9 Jul. 2023. The present invention relates to a new system and method of a knowledge system, and a new system and method of searching and displaying search results.

### BACKGROUND TO THE INVENTION

Knowledge bases are well known.

Knowledge graphs are well known.

Wikidata has a knowledge base with material. Things are defined as being an item that is referred to by an item label or title, and having a unique identifier.

Google is known for its Knowledge Graph which it uses as a database. An entity is the definition of a person or thing, and entities are connected by edges or links, forming a network graph.

In a Google search Google can draw on material from its Knowledge Graph and present it in a knowledge panel which is can be a selective display to the right-hand side of a list of search results.

In this document a knowledge system is used to define any knowledge system, knowledge base, knowledge graph, or anything else similar.

A problem with known knowledge systems is that they do not have an item or an entity that can represent a representation, such as a trademark or service mark, whether that trademark or service mark be a term such as wording or imagery that can be related to a person or thing.

A problem with known knowledge systems is that they don't have an item or entity that can represent anyone or anything, even when taking into account accepted censorship of data to disallow damaging material. This limits the possible vastness and richness of what a knowledge system or database could really be, and as a result, what richness could be included in knowledge panel search results.

A problem with known knowledge systems is that they depict a system of knowledge but with editing limits that prevents the organic growth of what would be a realistic knowledge graph of the world around us. As a result, many things are not in knowledge systems, which means the search engines that delve into them or interact with them are not as accurate to the world around us, compared to as they could otherwise be.

A problem with known knowledge panels is that they draw on material from a knowledge system that is not as vast and realistic to the world around us.

A problem with known knowledge panels that display some material from a knowledge system, is that a user to which data may relate doesn't have full control over what is presented about them, including that a user can't edit and up-date relevant knowledge panel material in real time, or close to that.

A problem with known searching on the internet is that the search query term used in a given search may not be completely matched in search results, leading to what can appear as incomplete search results.

A problem with known search results including knowledge panels, is that the item label or entity title is not linked to the search query term, leading to what can appear as inaccurate search results, or less than 100% accurate search results.

It is the object of this invention to provide a new system and method of a knowledge system, and a new system and method of searching and displaying search results, which includes overcoming these limitations.

### SUMMARY OF THE INVENTION

In a first aspect the present invention resides in a computer implemented method comprising:

one or more processors configured to perform operations including:
a method of an item system comprising:
a knowledge system or database including items, where at least an item represents a representation.

In a preferred embodiment of this aspect of the invention, an item can be used to represent anyone or anything, optionally with censorship to stop any damaging material.

In a preferred embodiment of this aspect of the invention the knowledge system can be represented by a graph that includes items or entities that represent the nodes, that are connected by links or edges to other items or entities.

In a preferred embodiment of this aspect of the invention each item is allocated an item identifier.

In a preferred embodiment of this aspect of the invention the item identifier is a persistent unique identifier.

In a preferred embodiment of this aspect of the invention the item representing a representation has an item label consisting of any term such as a wording reference, symbol, device, trademark or service mark.

In a preferred embodiment of this aspect of the invention the item label has corresponding imagery in the structure of the item.

In a preferred embodiment of this aspect of the invention the item representing a representation includes the item structure of at least an item label in the form of a term such as a wording reference, symbol, device, trademark or service mark, and also in the structure the item has an item identifier, and at least some imagery that may or may not be related to the item label.

In a preferred embodiment of this aspect of the invention the structure of the item includes further information, which can include anything else, which can include at least a URL, and or information at least relating to a web site.

In a preferred embodiment of this aspect of the invention an item label is in the form of a word trademark or word service mark and has in the item structure, imagery corresponding to the word trademark or word service mark.

In a preferred embodiment of this aspect of the invention any trademark or service mark is as defined or accepted by the World Intellectual Property Organization or any trademark or service mark office around the world.

In a preferred embodiment of this aspect of the invention the method also further includes a method of a search system comprising:

one or more processors configured to perform operations including:
parsing a search query of one or more words; and
locating the best match with the search query with an item representing a representation, then presenting the results of at least the best matched representation item label and or item imagery displayed in a knowledge panel.

In a preferred embodiment of this aspect of the invention a search system includes a search engine operating on the internet.

In a preferred embodiment of this aspect of the invention the knowledge panel is positioned anywhere in a computing system display and structured with the item label at the top section or at least near the top section of the knowledge panel, and with item corresponding imagery near the item label so that the item label and item corresponding imagery are connected by any way, including by appearance or by any meaning related to the item.

In a preferred embodiment of this aspect of the invention the knowledge panel includes additional material that relates to the item term such as a wording reference, symbol, device, trademark, or service mark, or corresponding imagery.

In a second aspect the present invention resides in a computer implemented method comprising:
one or more processors configured to perform operations including:
a method of up-dating in real time, or similar to that, material in a knowledge panel that corresponds to an item unique identifier, comprising; a knowledge system or database including items;
a search system;
a user accessing an account of a computer system;
a user providing, via the computer system user account, a selection of corresponding material they wish to have the option to be associated with the item in a knowledge panel;
the computer system verifying or reconciling selected corresponding material in a knowledge system thereby providing for the account user approved status for all verified or reconciled corresponding material which can include approval of any material or any number of files; and at any time after the corresponding material has achieved the approved status, the user accessing their user account to edit what would be displayed in the public knowledge panel with their item approved material, selecting approved corresponding material from their account, and such approved corresponding material being displayed in the knowledge panel in real time or similar to that, based on when a search on the item is conducted and best matched by a user.

In a preferred embodiment of this aspect of the invention the search system includes a search engine operating on the internet.

In a preferred embodiment of this aspect of the invention the computer system includes any computing system, including account system for users connected to a search system including a search engine.

In a preferred embodiment of this aspect of the invention any amount of corresponding material files can be selected by the user to seek verification or reconciliation in the knowledge system by a search system such as including a search engine, for potential use in a knowledge panel.

In a preferred embodiment of this aspect of the invention the corresponding material files are any number of files, including of any type and in any format, including any amount of image files, or video files, or both.

In a preferred embodiment of this aspect of the invention any amount of approved corresponding material files can be stored in a user account creating a library of approved corresponding material files, for potential use in a knowledge panel.

In a preferred embodiment of this aspect of the invention material that is approved or reconciled by the computer system includes reconciling material that is up-dated to be present or verified in a knowledge system.

In a preferred embodiment of this aspect of the invention the corresponding imagery that is up-dated in real time or similar to that, in a knowledge panel, is a part of a cross-pollination process as the item label and or corresponding imagery is the same as used in a communication strategy in any applicable setting such as on the internet and or in the world around us, thereby linking the item and corresponding material to multiple locations at once, and where the real time occurrence of that relates to a contemporary or relevant message to the public.

In a preferred embodiment of this aspect of the invention the imagery that is up-dated in the knowledge panel is part of a marketing campaign by being the same item label and or corresponding imagery used in a contemporary marketing campaign in any applicable setting, such as on the internet and or in the world around us.

In a preferred embodiment of this aspect of the invention the corresponding material that is up-dated in the knowledge panel takes the time duration of between real time and less than 3-7 days to be displayed to the public in the knowledge panel, from the time a user selects such approved material from their approved selection of material.

In a third aspect the present invention resides in a computer implemented method comprising:
one or more processors configured to perform operations including:
a method of providing for an entity of a knowledge panel to choose at least some of what is presented in their knowledge panel, and in a timely way, including by up-dating material in a knowledge panel, comprising:
a party that manages at least a knowledge panel, that has an account system for users;
a party that wishes to change at least some of a knowledge panel display, as an account holder with the management party;
the account holder being verified by the account system for editing at least some of the display of a knowledge panel;
the account holder providing material to up-date; and
the account system verifying material to up-date and approving for presentation in a knowledge panel.

In a preferred embodiment of this aspect of the invention an account system is a system that manages user accounts, such as related to a search system including a search engine system, or related to a knowledge system or database, or any other system.

In a preferred embodiment of this aspect of the invention the account system used to up-date material includes at least a section for the item label or item label term such as wording, and or a section for up-dating the item imagery, wherein having minimal sections of material to approve allows the process of approval to occur in an efficient way, or in a more streamlined way, as compared to if there were otherwise for example, more than one or two sections of material to approve.

In a preferred embodiment of this aspect of the invention the account system used to up-date material includes at least a section for customising the design or appearance of the item label or item label term such as wording, including by the variables of any or all of the elements and principles of design, including by providing any applicable design or custom data, which can include an image file of a chosen design or designs, and or when using text then setting the specifications for the text design, including any of the variables of font type, size, weight, colour, or anything else applicable.

In a preferred embodiment of this aspect of the invention the material up-dated for display in a knowledge panel occurs in real time, or at least less than around 3-7 days.

In a fourth aspect the present invention resides in a computer implemented method comprising:
one or more processors configured to perform operations including:
a method of a top-level domain system comprising at least:
a term such as a wording reference indexed to a unique identifier.

In a preferred embodiment of this aspect of the invention the top-level domain system includes a database, including at least a term such as wording, indexed in relation to an item or entity, or any number of applicable terms indexed so as part of a database.

In a preferred embodiment of this aspect of the invention a term such as a wording reference is indexed to be corresponding to any of an item unique identifier, or an entity unique identifier, or a domain name, or a URL, and where the unique identifier can include a persistent unique identifier.

In a preferred embodiment of this aspect of the invention a term such as a wording reference can be any expression, including any letter or letters, or character or characters, or symbol or symbols, or word or words, or any text, or any search query, or combination or permutation of these variations.

In a preferred embodiment of this aspect of the invention any number of terms such as wording references or wording identifications can be indexed to the same item unique identifier, or the same entity unique identifier, or to the same domain name, or to the same URL.

In a preferred embodiment of this aspect of the invention the method is also comprising:
one or more processors configured to perform operations including:
a method of a knowledge panel comprising:
a knowledge system or database including items or entities;
a search system;
a search query;
parsing a search query; and
locating the best match of the search query with a term such as a wording reference in the top-level domain system, then identifying the unique identifier of the item, then retrieving the corresponding material of the item from the knowledge system or database, and presenting the knowledge panel material in a knowledge panel with the best matched search query as the term, as the item label thereby replacing the original item label, or presenting the best matched search query as the term, as an additional term such as a wording reference to be presented at the same time as the original item label in the knowledge panel

In a preferred embodiment of this aspect of the invention at least a term such as a wording reference is displayed in replacement of the item label, in the same or similar position, or at least near the same position, as to where the original item label would usually be.

In a preferred embodiment of this aspect of the invention the term such as a wording reference is displayed at the same time as the original item label, near the original item label, or near the imagery, or anywhere in the knowledge panel display.

In a preferred embodiment of this aspect of the invention when material is displayed in a knowledge panel, when there are multiple terms such as wording references or such as wording identifications indexed to one item unique identifier, each different term such as a wording reference or such as a wording identification acts to be interchangeable with the other terms such as wording references or such as such as wording identifications, to replace the original item label, or co-exist with the original item label when being presented in a knowledge panel.

In a preferred embodiment of this aspect of the invention the top-level domain system provides for a searched term such as wording on the internet as a means to find at least a key domain name of a given item, or other relevant material or data, via display of an item's corresponding material including at least a key domain name, in a resulting knowledge panel display.

In a preferred embodiment of this aspect of the invention an item can have any number of terms than can act as indexed via the top-level domain system, to its unique identifier, where each term can act as an item label to replace the original item label, or where each term can be presented at the same time as, and co-exist with the original item label

In a preferred embodiment of this aspect of the invention the best match of the search query with a term such as a wording reference in the top-level domain system provides for identification of the item unique identifier, and with the unique identifier the item corresponding material can be looked up, found and retrieved from the knowledge system or database, for the item material to be displayed in a knowledge panel with the term such as a wording reference included.

In a preferred embodiment of this aspect of the invention a search system includes a search engine system, which can include a search engine.

In a fifth aspect the present invention resides in a computer implemented method comprising:
one or more processors configured to perform operations including:
a method of a knowledge panel design system including:
specifications of design or appearance of at least part of a knowledge panel, in accordance with the variables of any or all of the elements and principles of design.

In a preferred embodiment of this aspect of the invention the knowledge panel design system includes a database, with at least a part of a knowledge panel indexed to design or custom data of any type, and if using text then setting any relevant text design parameters, which can include font type, size, weight, colour, and any other relevant design feature.

In a preferred embodiment of this aspect of the invention the knowledge panel design system includes a database, with at least a part of a knowledge panel being the item label or item label term such as a wording reference or terms such as wording references, indexed to design or custom data of any type, and if using text then setting any relevant text design parameters, which can include font type, size, weight, colour, and or any other relevant design feature or features.

In a preferred embodiment of this aspect of the invention a user account of a knowledge panel can log on to the knowledge panel design system and edit their knowledge panel.

In a preferred embodiment of this aspect of the invention the method is also comprising:
one or more processors configured to perform operations including:
a method of a knowledge panel comprising:
a knowledge system or database including items or entities;
a search system;
a search query;
parsing a search query;
locating an item;
locating an item unique identifier in a knowledge system or database, with material for a knowledge panel display;
locating the item unique identifier in the knowledge panel design system with design specifications to display in a knowledge panel to the public;
formatted knowledge panel material ready to present; and
presenting knowledge panel to the public.

In a preferred embodiment of this aspect of the invention the knowledge panel design system can be part of or integrated with a knowledge system or database.

In a preferred embodiment of this aspect of the invention the knowledge panel design system includes a database of one or more item unique identifiers, each indexed to respective design specifications.

In a sixth aspect the present invention resides in a computer implemented method comprising:
one or more processors configured to perform operations including:
a method of a search query term being matched in search related material, wherein the search query term is the same term, or matched term, present in at least some of the search related material.

In a preferred embodiment of this aspect of the invention the matched term is a repeat of the search query term, or the matched term is a duplication of the search query term, that results in a match, being the matched term with the search query term.

In a preferred embodiment of this aspect of the invention an item or entity is registered in an account system with a term such as a wording reference indexed to the item or entity, where the term such as a wording reference is a match to the search query term.

In a preferred embodiment of this aspect of the invention the search related material includes search results, which can include at least part of the material in a knowledge panel.

In a preferred embodiment of this aspect of the invention the search query term is auctioned, wherein the highest bidder wins the auction, and wherein the auction winner has the right to manage where the search term match is presented in respect of the search related material.

In a preferred embodiment of this aspect of the invention the auction is in real time.

In a preferred embodiment of this aspect of the invention the search query term and matched term relates to any of: the auction winner; and or an item label, and or an entity title.

In a preferred embodiment of this aspect of the invention the search query term and or matched term to that applies to any jurisdiction, which can include any geographical jurisdiction being made up of any number of places, which can include any of: a town; and or a city; and or a state; and or a country; and or more than one country; and or a continent; and or more than one continent; and or across the world.

In a preferred embodiment of this aspect of the invention the method is also comprising:
one or more processors configured to perform operations including:
a method of search related material system comprising:
a knowledge system or database including items or entities;
a search system;
a search query;
parsing a search query;
determining search related material; and
presenting search related material, including presenting the search query term or matched term to that with, or as part of, the search related material.

In a preferred embodiment of this aspect of the invention the matched term is a repeat of the search query term, or the matched term is a duplication of the search query term, that results in a match, being the matched term with the search query term.

In a preferred embodiment of this aspect of the invention an item or entity is registered in an account system with a term such as a wording reference indexed to the item or entity, where the term such as a wording reference is a match to the search query term.

In a preferred embodiment of this aspect of the invention the search related material includes search results presented in a knowledge panel.

In a preferred embodiment of this aspect of the invention the search query term or match to that is in addition to the item label being presented, or entity title being presented.

In a preferred embodiment of this aspect of the invention presenting the search query term or match to that is instead of, or in replacement of, the item label, or entity title, being presented.

In a preferred embodiment of this aspect of the invention the search query term is auctioned, wherein the highest bidder wins the auction, and wherein the auction winner has the right to manage where the search term match is presented in respect of the search related material.

In a preferred embodiment of this aspect of the invention the auction is in real time.

In a preferred embodiment of this aspect of the invention the search query term or match to that, is a term related to any of: the auction winner; and or an item label; and or an entity title.

In a preferred embodiment of this aspect of the invention the search query term and or matched term to that applies to any jurisdiction, which can include any geographical jurisdiction being made up of any number of places, which can include any of: a town; and or a city; and or a state; and or a country; and or more than one country; and or a continent; and or more than one continent; and or across the world.

In a preferred embodiment of this aspect of the invention the search query term is indexed in a top-level domain system as a term such as a wording reference, and is indexed in relation to, or to correspond to any of: an item; an entity; a domain; a unique identifier.

In a preferred embodiment of this aspect of the invention the search query term is indexed in a top-level domain system in real time.

In a seventh aspect the present invention resides in a computer implemented method comprising:
one or more processors configured to perform operations including:
a method of presenting search related material comprising:
a knowledge system or database including items or entities;
a search system;
a search query;
parsing a search query;
checking in a top-level domain system if the search query term is registered in it or not; and
if the search query term is not registered in the top-level domain system, then the search system checking the knowledge system or database to confirm whether or not the term is indexed to an item or used as an item label, and if not, then providing for an auction of the term for exclusive use by party in relation to search related material; or
if the search query term is registered in the top-level domain system, then the search system exclusively using the term in relation to search related material; or
if the search query term is registered in the top-level domain system, then the search system providing for an auction of the term for exclusive use by at least a party other than to whom the term is registered to in the top-level domain system, and the term being used in relation to search related material.

In a preferred embodiment of this aspect of the invention the search related material includes being presented in a knowledge panel.

In a preferred embodiment of this aspect of the invention the search query term is matched by any process, including by being indexed, corresponded to, related to, duplicated, repeated, or copy and pasted, and presented in the search related material of a knowledge panel.

In an eighth aspect the present invention resides in a computer implemented method comprising:
one or more processors configured to perform operations including:
a method of a top-level domain system comprising at least:
a term such as a search term connected via relationship with at least a part of search related material.

In a preferred embodiment of this aspect of the invention the search related material includes a term that is a fractal of the search term.

In a preferred embodiment of this aspect of the invention the at least a part of search related material includes a term that is the same term or matched term as the search term, wherein the connection between the search term and search related material is created by the same term being present in both, and at the same time, and wherein the relationship between the terms is that the term in the search related material is a fractal of the search term.

In a preferred embodiment of this aspect of the invention the search related material includes a term that is a fractal of the search term, and wherein the term is the domain for a sub-set of content or data that can include a .com domain name.

In a ninth aspect the present invention resides in a computer implemented method comprising:
one or more processors configured to perform operations including:
a method of a top-level domain system including;
a term made up of a first term or any number of first terms, and optionally including being followed by a second term or any number of second terms,
wherein the whole term, that is including the first and second terms, is indexed to a unique identifier.

In a preferred embodiment of this aspect of the invention, the first term can be any term or number of terms and can include: a personal name, a business name, a company name, an object name, a name for anything, a name for anyone, a reference, a description, a made-up term, or anything else.

In a preferred embodiment of this aspect of the invention the second term or any number of second terms can include: between 1 and 10 terms that further define or relate to the first term, or between 1 and 10 second terms that simply follow the first term.

In a tenth aspect the present invention resides in a computer implemented method comprising:
one or more processors configured to perform operations including:
a method of a top-level domain system including;
a term made up of a first term or any number of first terms, and optionally followed by a second term or any number of second terms, wherein the term, that is the combined first term or terms and the second term or terms, is indexed to a unique identifier, or wherein the term is indexed to any number of unique identifiers.

In a preferred embodiment of this aspect of the invention two different unique identifiers are indexed to the same term.

In a preferred embodiment of this aspect of the invention two or more different unique identifiers are indexed to the same term.

In an eleventh aspect the present invention resides in a computer implemented method comprising:

one or more processors configured to perform operations including:
a method of a social media system including;
verified material; and
at least a post from a user.

In a preferred embodiment of this aspect of the invention the verified material is presented from a neutral point of view.

In a preferred embodiment of this aspect of the invention the post made by a user is of material from the first-person point of view, such as being a quote, testimony, opinion, experience, or share or any type of first-person presentation from a user.

In a preferred embodiment of this aspect of the invention the post is of material that is verified such as being part of a knowledge graph.

In a preferred embodiment of this aspect of the invention the material presented from a neutral point of view is a stable action or a relatively long-lasting action, and the post is a current action or a relatively changeable action, wherein the stable action and the current action combine to provide life and vibrance to search results, such as including a knowledge panel, and the item or entity to which the knowledge panel is about.

In a preferred embodiment of this aspect of the invention all material is verified, and where there is a cross-pollination of material including content presented from a neutral point of view, which can include material from the past or to date, and or relating to the future, and material including content posted which is current, being of material that is from the current timeframe, or the past, and or relating to the future.

In a twelfth aspect the present invention resides in a computer implemented method comprising:
one or more processors configured to perform operations including:
a method of a domain name comprising a unique term that is indexed to at least a unique identifier.

In a preferred embodiment of this aspect of the invention the domain name is a unique term and wherein the unique identifier has content indexed to it, or a corresponding unique identifier in a knowledge graph has content indexed to it.

In a preferred embodiment of this aspect of the invention the content that is indexed to the unique identifier is any content and in any format.

In a preferred embodiment of this aspect of the invention the domain name is registered in a registration system with at least the domain name comprising a unique term indexed to at least a unique identifier wherein the unique identifier optionally has content indexed to it, or a corresponding unique identifier in a knowledge graph has content indexed to it.

In a thirteenth aspect the present invention resides in a computer implemented method comprising:
one or more processors configured to perform operations including:
   a method of presenting search related material comprising:
   a knowledge system or database including items or entities;
   a domain name registration system or database;
   a search system;
   a search query;
   parsing a search query;
   checking a domain registration database for a domain name that is a unique term;
   if the domain name is registered in the database then retrieving the domain name and presenting it in a knowledge panel; and
   locating the unique identifier indexed to the domain name and then locating that unique identifier in a knowledge system or database and retrieving content indexed to the unique identifier in the knowledge system or database or knowledge graph and presenting that in a knowledge panel together with the domain name; or
   if the domain name is not registered in the domain name system or database then not presenting a domain name and corresponding content indexed to a unique identifier in a knowledge panel from the search query.

In a fourteenth aspect the present invention resides in a computer implemented method comprising:

one or more processors configured to perform operations including:
a method of a knowledge panel comprising any combination of: space for a domain name, space for an image, space for content, space for resources such as a website and social media icons or links, and space for at least a social media post.

In a preferred embodiment of this aspect of the invention the space for the domain name and the space for the image, are approximately the same, or are the same.

In a preferred embodiment of this aspect of the invention the order of things of the knowledge panel reading from top to bottom is the area for the domain name, then area for the image, then area for the description, then area for the text content, then area for the resource links, then area for at least a social media post.

In all aspects of the invention, and preferred embodiments, and embodiments, a user, and or an item, and or entity that has a unique identifier has an account in an account system. This account system can include any structure form or process known in the industry. This account system can be used to manage and interact with, where applicable, each implementation of the invention herein.

In all aspects of the invention, and preferred embodiments, and embodiments, optionally a user, and or an item, and or entity that has a unique identifier is registered in an account system. This account system includes a registration system that can include an item or entity having, and or acquiring, or paying for the right, by any applicable process, to exclusively use at least a term such as a wording reference that is indexed to, or corresponds to, or relates to, or is linked to, a unique identifier. The registration process can include for example, a user searching for and applying for the exclusive use of a term to be used in relation to a unique identifier. Subject to a term being available, the user for example inputs identification content such as at least unique identifier, or there is a link to that in a knowledge system, and the chosen term is paid for and accepted as registered in the account system. The structure, form and process of the registration system can include being of the same structure, form and process of any known registration system in any applicable industry.

In some aspects of the invention, where there is an auction process, including for a term, users that are part of the auction process register in an account system to be signed up for each applicable auction process. The registration process for the auction process can include a user confirming settings and parameters, including for auctions in real time, such as bidding parameters, bidding limits, payment methods, potential lag or considerations for biding, and anything else applicable. The structure, form and process of the auction process, whether that be in real time or not, can be the same as is known and used in the industry, or that which is used in any other applicable industry.

Advantages of the aspects of the invention herein, including the top-level domain system, include that there can be one or more terms or key words that when searched as a term, connect to or link to a specified item or entity in search related material such as search results in a definite way. Such definite and specific search term and display systems of the inventions herein including the top-level domain system, are more accurate and more precise than conventional search engines, including SEO or search engine optimization processes. Further advantages of the inventions herein include search engines that use the inventions herein obtain greater engagement with users, including a user doing a search and the item or entity that becomes found from a search query. Further advantages of the inventions herein include creating more engagement with a user via connection with the fractal process, and by a connection between the user, the computing system and nature. Further advantages of the inventions herein include connecting a user to nature via the inventions herein, and experiencing nature via the fractal process, via the inventions herein.

In all preferred embodiments and embodiments of the invention known systems and methods, apparatuses and any other implementation items or things can be used to implement all the aspects of the invention.

In further preferred embodiments of further aspects of the invention any combination or permutation of any number of aspects of the invention or preferred embodiments or embodiments can be made with any number of other aspects of the invention or preferred embodiments, or embodiments, creating the definition of new aspects of the invention, and new preferred embodiments, or embodiments.

In all preferred embodiments of the invention there can be any combination or permutation of the elements and principles of design (as are known in the design industry) used for any given embodiment, or any range of embodiments.

In preferred embodiments of various aspects of the invention there are the systems and methods as represented or described in this document.

In preferred embodiments of various aspects of the invention there are the systems and methods as represented or described in the figures or drawings.

### BRIEF DESCRIPTION OF THE DRAWINGS

FIG. 1 is a schematic diagram of an aspect of the invention;

FIG. 2 is a schematic diagram of an aspect of the invention;

FIG. 3 is a schematic diagram of an aspect of the invention;

FIG. 4 is a schematic diagram of an aspect of the invention;

FIG. 5 is a schematic diagram of an aspect of the invention;

FIG. 6 is a schematic diagram of an aspect of the invention;

FIG. 7 is a schematic diagram of an aspect of the invention;

FIG. 8 is a schematic diagram of an aspect of the invention;

FIG. 9 is a schematic diagram of an aspect of the invention;

FIG. 10 is a schematic diagram of an aspect of the invention;

FIG. 11 is a schematic diagram of an aspect of the invention;

FIG. 12 is a schematic diagram of an aspect of the invention;

FIG. 13 is a schematic diagram of an aspect of the invention;

FIG. 14 is a schematic diagram of an aspect of the invention;

FIG. 15 is a schematic diagram of an aspect of the invention;

FIG. 16 is a schematic diagram of an aspect of the invention;

FIG. 17 is a schematic diagram of an aspect of the invention;

FIG. 18 is a schematic diagram of an aspect of the invention;

FIG. 19 is a schematic diagram of an aspect of the invention;

FIG. 20 is a schematic diagram of an aspect of the invention;

FIG. 21 is a schematic diagram of an aspect of the invention;

FIG. 22 is a schematic diagram of an aspect of the invention;

FIG. 23 is a schematic diagram of an aspect of the invention;

FIG. 24 is a schematic diagram of an aspect of the invention;

FIG. 25 is a schematic diagram of an aspect of the invention;

FIG. 26 is a schematic diagram of an aspect of the invention;

FIG. 27 is a schematic diagram of an aspect of the invention;

FIG. 28 is a schematic diagram of an aspect of the invention;

FIG. 29 is a schematic diagram of an aspect of the invention;

FIG. 30 is a schematic diagram of an aspect of the invention;

FIG. 31 is a schematic diagram of an aspect of the invention;

FIG. 32 is a schematic diagram of an aspect of the invention;

FIG. 33 is a schematic diagram of an aspect of the invention;

FIG. 34 is a schematic diagram of an aspect of the invention;

FIG. 35 is a schematic diagram of an aspect of the invention;

FIG. 36 is a schematic diagram of an aspect of the invention;

FIG. 37 is a schematic diagram of an aspect of the invention;

FIG. 38 is a schematic diagram of an aspect of the invention; and

FIG. 39 is a schematic diagram of an aspect of the invention.

### DETAILED DESCRIPTION OF PREFERRED EMBODIMENTS

Below are “further definitions” of terms that are used in this document, where the definitions below are to be read as in addition to the definitions of the terms as accepted in the world around us, and in addition to the definitions as used in this document, and in addition to the definitions as used in the context of this document. These further definitions are:
a. “account” means an account of any known structure, form or process, which can include where a user, or item or entity, manages or interacts with, where applicable, each of the implementations of the invention herein. This account can include the system and method of a term such as a wording reference being registered in an account system.
b. “anyone or anything” with regard to defining material, including items and entities, includes optionally being censored to stop any damaging material.
c. “best match” relating to a search query means the closest match of a search query, where a complete or whole match or 100% match is the best match where a complete match is possible, and scaling down from that, where there is not a whole or complete match possible, the best match is the closest match to that, which is the search material with the most similar term such as wording to the search query. For example, with the search query “Ice Cold Refreshment” compared to search material with “Ice Cold Refreshment” that is a whole or complete match or 100% match, which is the best match. With a different search query of “Ice Cold Refreshments”, where there is no search material with that search term, but where there is search material with “Ice Cold Refreshment” then the search material of “Ice Cold Refreshment” is the scaling down match from a whole or complete match, to therefore be the next closest match or best match of “Ice Cold Refreshment”. For example, also these processes take into account different terms, and or terms being translated from one language to another.
d. “connection via relationship” means connected via any relationship, including there being a relationship apparent via meaning, or including a relationship being formed by a term being present in a search query, and the same term being present in search related material. This apparent repeat or duplication of the term creates a connection via relationship, the connection being the term present in two different locations, and the relationship being a term that is self-similar, or a term in the search related material being a fractal of the search term.
e. “data processing apparatus” means any apparatus that can process data, including apparatus for any computer implemented system, and or any apparatus for any other computing related system.
f. “entity” means someone or something, and can include anyone or anything, which can include everyone and everything, and includes all living beings, and all things in the universe physical and non-physical, which can be part of a knowledge system, and which can also be called an item.
g. “image” means any image in any format, including format of static or moving, such as video.
h. “imagery” means any type, form or embodiment of an image or images.
i. “indexed” means any content or data in a system that corresponds or is in position to relate to other content or data. Being indexed can include being a direct entry in a database, or being an indirect entry in a database. Being indexed can include two or more data or content things being related to each other in a computing system. Examples include, a term in a database that corresponds to a unique identifier of any sort or form. Examples include, a search query term that is matched in search related material, such as by being auctioned first, and being copy and pasted into search related material, or where the search query term is copy and pasted into search related material with no payment. Examples include where the search query term may or may not relate in any way to any of the content of the item or entity the subject of the search related material where the search query term is matched and is present in or related to.
j. “item” means someone or something, and can include anyone or anything, which can include everyone and everything, and includes all living beings, and all things in the universe physical and non-physical, which can be part of a knowledge system, and which can also be called an entity.
k. “item label” means item title or item name, or entity name or entity title, or reference to any of these.
l. “item system” means computer implemented system of items in a database.
m. “knowledge panel” means a panel or viewing section in any format, of any size, in any part of computing system or computing system display, of presented material that can include results from a knowledge system, results from internet search results, or any other search, and which can include the presentation of any material, including non-searched material, whether that be related to a search query or not, or whether that be related to an item or entity or not.
n. “knowledge path” means system of connection of items or entities, or pathway of connecting knowledge, and includes a knowledge system, knowledge base, knowledge graph, database, or similar such systems.
o. “knowledge system” means a system of knowledge or a system with relationships of knowledge or data, and includes a knowledge base, knowledge graph, knowledge path or any other information, data, material, or knowledge relationship system or database.
p. “match” or “matched” means where the whole search query is matched in full to a term in searchable material, whilst including where the search query and the term in searchable material are not case sensitive. The process of obtaining a match of the search query term can include by any applicable system, including as described herein. The process of obtaining a match of the search query term includes by the term being indexed to a unique identifier in a top-level domain system, where the unique identifier is used to locate corresponding item details in a knowledge system and display search related content in search related results with the indexed term which is the same as the search term. The process of obtaining a match of the search query term also includes the search term being auctioned, and where the search term is included in the search related material. The process of obtaining a match of the search term also includes where the term is copy and pasted from the search query input to the search related material output, where such term can be auctioned or simply applied in the search related material without payment. The process of obtaining a match of the search query term includes where the search term is the same as the item label.
q. “material” means material, data, content, design specifications, parameters, settings, or any information in any format.
r. “one or more processors” means any number of the following processors, that can operate separately, or simultaneously: in a relation to a single computer; and or in relation to multiple computers; and or in relation to any number of servers or similar systems; and or in relation to any applicable computing system hardware, software or firmware; and or any applicable type and number of data processing apparatus; and optionally where any of these systems and methods are connected to the internet, and or operate on the internet.
s. “real time” means occurring in the current timeframe of a process, or in a relatively efficient or fast time frame of a process.
t. “reference” means where the term includes acting as a reference. This reference includes having meaning, or the term having no meaning in relation what it is referred to, or where the term can have any relationship to what it is referred to, such as a given item or entity. In the case of a term such as a search query term that is a wording reference to a given item or entity in search related material, the term can include having meaning in relation to an item or entity, or the term can include having no meaning in relation to an item or entity, or the term can have any relationship to a given item or entity.
u. “registered in an account system” means a user, or item or entity registered in a system such as an account system, a search system, or search engine, or knowledge system, or any other system, where the registration system includes a record of at least an identification or ID of a party, which can include a unique identifier for application in relation to the exclusive use of one or more terms. The term such as a wording reference includes being exclusive to a unique identifier, item or entity, from being bought, hired, licensed or commercialized in any way, which can include being paid for by auction, whether in real time or not. The structure, process and form of the registration system can be in accordance with any known registration system.
v. “search query term” means any search query in any form, which is referred as a term. A search query term includes being used in a search, including in a search system.
w. “search system” means a search system, a search engine system, and anything else related to that in an operating system, such as one or more servers, searching facilities, user account systems, account management systems, and optionally with connectivity and interaction facilities with a knowledge system, including a knowledge base or knowledge graph, or any database or system, and including having facilities to present material in a knowledge panel.
x. “search” process or “search query” process means searching for a match, complete match, or best match, or closest match, or related to a match.
y. “search related material” means any material in relation to a search query, and in any format, including any material in a list of search results, and or including any material in a knowledge panel, and or including any other material in any applicable format.
z. “term” means any term or any number of terms, or any expression or any number of expressions, or any word or any number of words, or any word reference, or any wording reference, or any number or any number of numbers, or any character or any number of characters, including a search query or any number of search queries, and or any combination or permutation of these definitions. With all of these definitions, a term can be in any form. Ordinarily, for a term to be used in a top-level domain system, including for a term to be put to auction, the term must be available for use including under this patent, including for exclusive use for any term, including temporarily, or for long term, and where the term is not already used in a conflicting way, such as being an item label of a conflicting item, in a knowledge system or database, or used in any other way that would fundamentally prevent the use of the term including under this patent. Examples of a term include: a letter, a symbol, a word, a number of words, text, including with reference an item or item label, or with reference to an entity name or title. Examples of a term include: where the term is symbolic, descriptive, non-descriptive, a device, a trademark, a service mark, or anything else applicable.
aa. “top-level domain system” means a system for term that is a domain for a subset of content or data, including for at least an aspect of a given item or entity, such as including a .com domain name, or any other domain name. Ordinarily, for a term to be used in a top-level domain system, including for a term to be put to auction, the term must be available for use including under this patent, including for exclusive use for any term, including temporarily, or for long term, and where the term is not already used in a conflicting way, such as being an item label of a conflicting item, in a knowledge system or database, or used in any other way that would fundamentally prevent the use of the term including under this patent. This system provides for a term to act as a gateway, or lead to, at least an aspect of an item or entity. This system includes where a single given term can be a gateway to, or lead to, a greater amount of data or content than the size of the term. This system can include a top-level domain database. The top-level aspect process includes any term that provides a gateway to, or leads to, at least a part of an item, or an entity, such as a .com domain name or other domain name. The form of the term may or may not relate in any way to the given item, or entity, such as a domain name, that it is a gateway to. This gateway to an item or entity includes preceding the location of a .com domain address for example. This gateway to an item or entity occurs by the term, which can be in the form of a search query, being connected to at least some search related material. This connection to at least some search related material can be achieved by various ways, including by a given term being indexed in a database to at least an aspect of an item or entity, such as a to a unique identifier. Alternatively, this connection to at least some search related material can also be by the search query being matched, or repeated, or duplicated such as being copy and pasted in the search related material. This system includes where a domain term is connected via relationship, such as being a term in search related material that is a fractal of a search query term. This system can also be called a top-level wording system (for wording applications), a top-level domain name system, a knowledge panel domain name system, a panel domain system, panel domain, panel domains, or anything else applicable. Advantages of the top-level domain system include that there can be one or more terms, including many, terms or key words that when searched as a term link to a specified item or entity in search related material such as search results in a definite way. Such specific or definite search term and display systems of the inventions herein including the top-level domain system, are more accurate and more precise than conventional search engines, including SEO or search engine optimization processes.
bb. “wording” means any term including one or more words. Examples include at least a word that is meaningful, or at least a word that is not meaningful. Examples includes at least a word that may or may not relate to a given item or entity.
cc. “unique identifier” means anything unique that provides identification or is related to identification, of anyone or anything in any form, which includes any unique identifier, including any unique identification or unique ID, including a unique number, a unique combination of at least a letter and at least a number, a Q identifier, a persistent unique identifier, a domain name, a URL, or anything else unique to a person, a thing, an item, an entity, or any other unique definition related to anyone or anything that provides identification or is related to identification. A unique identifier can help items to be able to link and connect with other items and material in a knowledge system or database, and or computing systems.

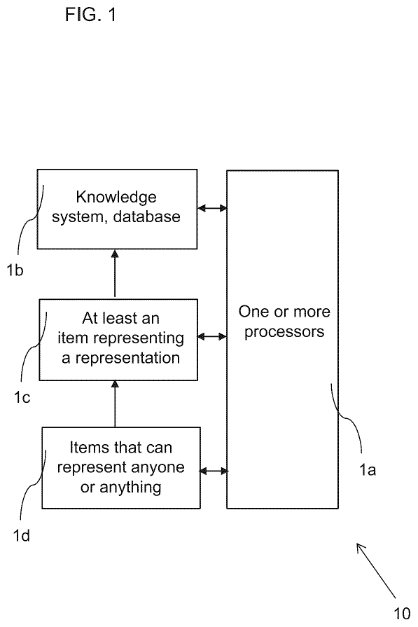

FIG. 1 shows a schematic diagram of an aspect of the invention, being a computer implemented method 10. This method 10 includes one or more processors 1a, connected to all parts of the method 10. 1b shows a knowledge system or database, which can include an item representing a representation 1c. System 1d shows that an item can be used to represent anyone or anything. System 1a can include one computer system and system and method to run the knowledge system, or database 1b. System 1a can also include any number of computers and servers connected to the internet that is in connection with the knowledge system or database 1b. In this way, an item 1c can represent a representation, such as a term such as a wording reference, description, symbol, device, trademark, service mark, or anything else that is a representation for anyone or anything 1d.

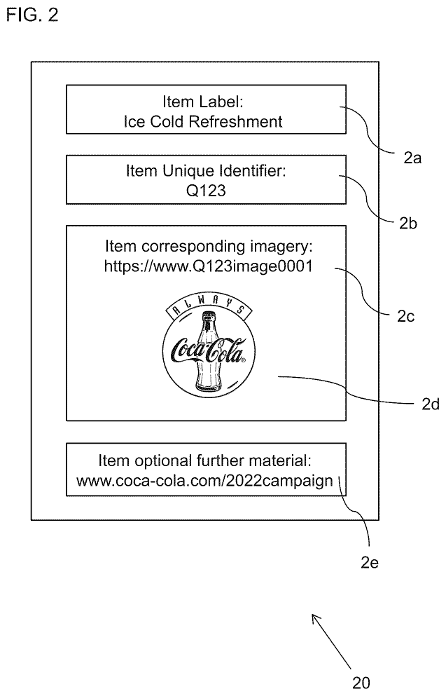

FIG. 2 shows the schematic diagram of an aspect of the invention, being a system and method of a structure of an item or entity 20, representing a representation, such as an item or entity trademark or service mark 2a and 2d. This method 20 is part 1c of FIG. 1 being an item representing a representation and part 1d of FIG. 1 being an item representing anyone or anything. The item or entity 20 includes an item label 2a, an item unique identifier 2b (theoretical sample shown by way of example) corresponding imagery link 2c (theoretical sample shown by way of example) and corresponding imagery 2d being a trademark (or in other embodiments could be service mark) image. This could be enough to define an item or entity. Item optional further material 2e can include further material, and includes a URL as shown 2e (theoretical sample shown by way of example). Further additional material 2e can include links or connections to other items or entities. For example, in this way, when a user does a search online for “Ice Cold” and the predictive text system shows “Ice Cold Refreshment”, the user can click on that. The search system such as a search engine, locates the item “Ice Cold Refreshment” in the knowledge system or database and is able to present search results in a list and or in a knowledge panel with the item label “Ice Cold Refreshment”, where the item material includes relation to the domain name “coca-cola .com” and other “Coca-Cola” material.

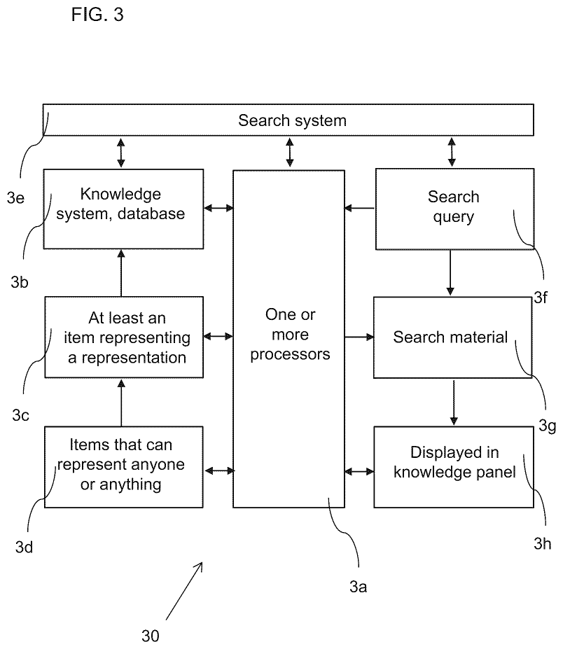

FIG. 3 shows a schematic diagram of an aspect of the invention, being a computer implemented method 30. This method 30 includes one or more processors 3a, connected to all parts of the method 30. A knowledge system or database 3b is shown, which includes at least an item representing a representation 3c, and items that can represent anyone or anything 3d. A search system 3e is connected to the knowledge system or database 3b, where the search system 3e can include a search engine, and or at least at least a computer on the internet as part of a computing system that can have a search conducted by the search system 3e, on the internet via a search query 3f. When a search is conducted the best match is obtained being an item representing a representation 3c, as part of the knowledge system or database 3b, search material 3g. Such search results are formatted and displayed in a knowledge panel 3h, that can be positioned anywhere in a screen or display, such as being viewable anywhere on a computer screen. By way of example, in this way, a user inputs a search query on the internet for “The Real” and the predictive text brings up “The Real Taste” and the user clicks on that as a search query 3f. The search system 3e locates in the knowledge system or database 3b that there is an item with the item label “The Real Taste” and the item material 3g is displayed as search material including search results in a list 3g and in a knowledge panel 3g with an item label of “The Real Taste” with material below it about “Coca-Cola”. In this way there can be a number of items representing representations such as terms such as wording references, that act as a way of direction to the unique material of an item, such as a domain name or other related material, where this way of direction is regarded as a top-level domain name system from a term such as a wording reference.

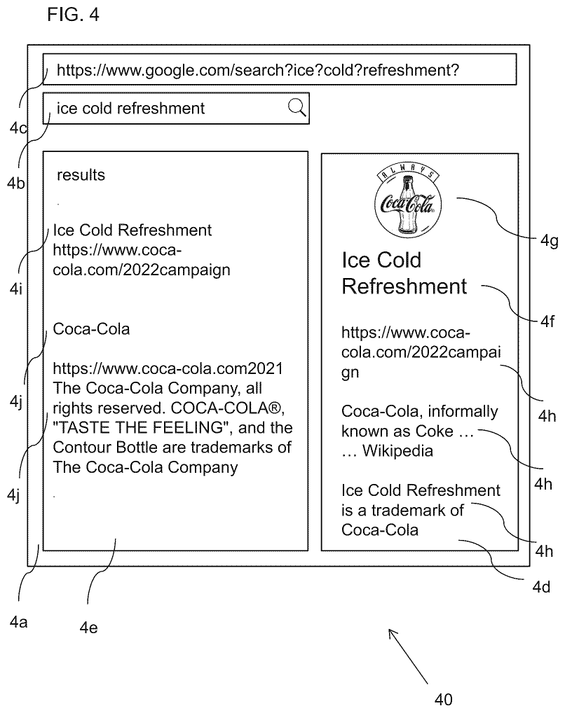

FIG. 4 shows a schematic diagram of an aspect of the invention, being a computer implemented method 40. The method 40 shows a display 4a via a computer screen of a computer connected to the internet (details of connection to the internet not shown). By way of example, a search query 4b is made for “ice cold refreshment”. The URL for the search query 4b is shown by way of theoretical representation at 4c. The area of the knowledge panel is section 4d and the list of search results is in section 4e. The search query 4b is a match to an item or entity with an item label, or entity title, “Ice Cold Refreshment” 4f, which is displayed as part of search material including search results in a knowledge panel 4d. The item label or entity name shows a term such as a wording reference 4f, for the account of “Coca-Cola”, that has the rights for the term such as wording “Ice Cold Refreshment” 4f. The rights for the term such as any applicable wording reference could be further managed by being registered in an account system, including for accounts holders of terms such as wording references and items or entities. This term such as a wording reference 4f could be interpreted as trademark or service mark 4f in this setting. The item label 4f has corresponding imagery 4g being a visual trademark (and in other embodiments that could be a service mark) that relates to the term such as a wording reference 4f of “Ice Cold Refreshment”. As the item label 4f and imagery 4g are close together they are visually connected by a viewer seeing the connection of the product “Coca-Cola” 4g being “Ice Cold Refreshment” 4f. Additional material is shown by way of example in the areas of 4h. At the top of the search material list 4e is a summary or reference 4i of the search result of “Ice Cold Refreshment” 4f. The search result listing is shown by way of example in the areas of 4j.

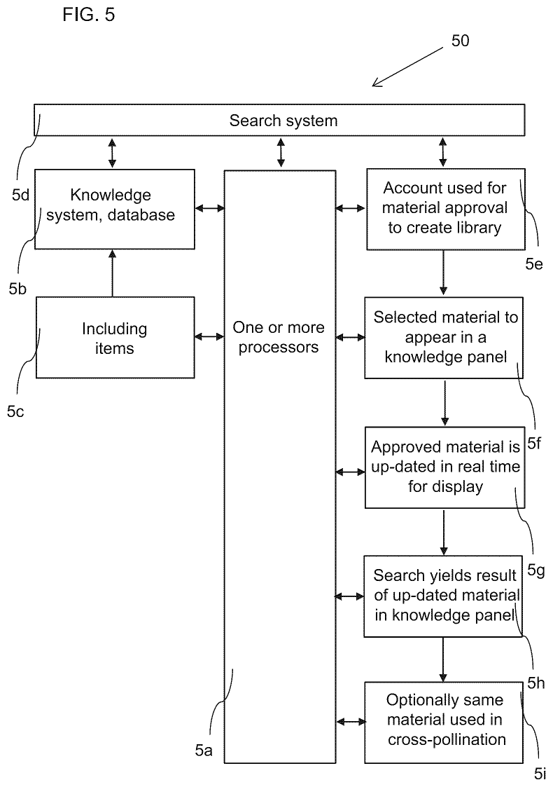

FIG. 5 shows a schematic diagram of an aspect of the invention being a computer implemented method 50. This method 50 includes one or more processors 5a connected to all parts of the method 50, where 5a includes multiple computers connected to the internet connected to servers (not shown) related to the search system 5d, being able to connect to and search, retrieve, and process material in the knowledge system, or database 5b. The knowledge system or database 5b includes various items 5c, also known as entities 5c. There are links or connections (not shown) of items or entities 5c to other items or entities 5c creating what could be called paths, pathways, networks, a system or graph (not shown). By way of example, a user with an account with the search system 5d, logs onto their account of an item or entity, and uploads a selection of material all for approval to correspond to their item label or entity name 5e. In this example 200 image files that relate to the item label “Ice Cold Refreshment” pertaining to “Coca-Cola” trademark (and in other embodiments a service mark could be used) imagery are uploaded for approval 5e, via the search system 5d. The search system 5d does approves all 200 images (not shown) by verifying all imagery on a Wikimedia page, where such material is verified in the knowledge system or database 5b. Following this process, the user then selects one of the approved images (with reference by way of example) as “Q123image0003” shown as 5f. This image is then up-dated in real time 5g, where it set to appear in the next search material for a user, of the item label or entity title, in a knowledge panel. In this way, when an internet user (not shown) makes a search query for the item label “Ice Cold Refreshment” and finds a match for the item term such as a wording reference 5h, that match is displayed in a knowledge panel 5h with corresponding up-dated imagery 5f. The imagery 5f can be up-dated in real time for display in a knowledge panel 5h, because the imagery 5f is already approved by the search system 5d. The item account user, “Coca-Cola” can optionally run a marketing campaign on Instagram and or on other parts of the internet about “Ice Cold Refreshment”. The term such as a wording reference or trademark or service mark of “Ice Cold Refreshment” and corresponding imagery 5f is the same term such as a wording reference or trademark or service mark and imagery as used on Instagram or other parts of the internet, and in retail shops in a given country, or multiple countries, creating cross pollination 5i. This type of cross-referencing of the same message, being the item label and corresponding imagery 5i, in various locations at the same time, helps emphasize and give reassurance of the stability and universality of a message, evoking a sense of nature by fractal messages.

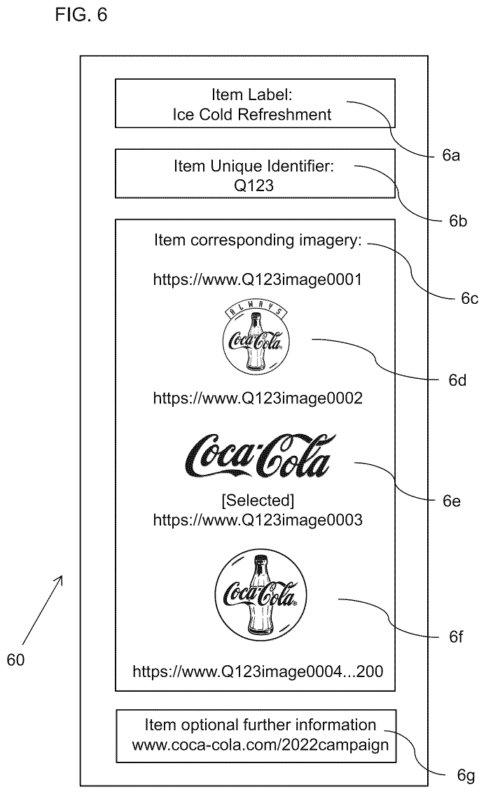

FIG. 6 shows a schematic diagram of an aspect of the invention, being a computer implemented method 60. This method 60 shows the structure of an item or entity as shown at 5c in FIG. 5. 6a shows the item label or entity name. The unique identifier 6b is shown by way of theoretical example, as a Q identifier (in other embodiments any form of unique identifier can be used). The item label corresponding imagery 6c shows by way of theoretical example 3 images of 200 referred to as part of the item, with 4 theoretical links to locate material in a knowledge system or database. 6d shows an example of corresponding imagery with link to locate material in a knowledge system or database. 6e shows another example of corresponding imagery with link to locate material in a knowledge system or database. 6f shows another example of corresponding imagery with link to locate material in a knowledge system or database. 6g shows optional further information related to the item or entity. By way of example, in this way, the account user has uploaded 200 image files for approval to be displayed at any time in relation to the item or entity in a knowledge panel. All 200 image files are on a Wikimedia page. The search system verifies and reconciles all 200 images as being present and connected in the knowledge system or knowledge graph. Once that is done, which may take for example between real time and 14 days, the account user logs onto their account and selects one image to be displayed in their knowledge panel. Such image is shown by way of example as “Selected”, being related to link “https://www.Q123image0003”. As this image is approved in the search system with all other 199 image files, when any of the files are selected for display in a knowledge panel, it is up-dated for display in real time to appear in a knowledge panel. With this computer implemented method 60 when a user does a search on “Ice Cold Refreshment” the search material including search results include a knowledge panel with the item label “Ice Cold Refreshment” and corresponding trademark or service mark imagery as shown at 5h in FIG. 5. As this imagery 6c is up-dated for public view in real time, the user of the account can easily change corresponding imagery to something else from their library in a fluid manner. That process can allow the same item label and imagery as also used in a marketing campaign on the internet, and in the world around us, to all be up-dated or changed at about the same time. This creates a unified system, where a unified message can be presented to the public in a co-ordinated way, or in a reliable way, unifying the message to the public. This reliable process can allow greater flexibility with marketing campaigns and public messaging. This is the system of cross-pollination as shown in 5i in FIG. 5.

With reference to FIGS. 1-6 a further preferred embodiment of the invention will be described using a theoretical example, and referring to the parts of the respective figures in principle. “Ty Rant the ant” wants to communicate rolling messages to the public via a knowledge panel as shown by 4d in FIG. 4. “Ty” creates an account with a search system as shown by 5d in FIG. 5. Setting up the account is done in the usual way of things for app account holders, so to sign in “Ty” uses a username and password. “Ty” does a search via the search system as shown by 5d in FIG. 5, to have the rights for the term such as the wording trademark “Ty Rant the ant”. “Ty” finds out from the top-level domain system or top-level domain database system that the term such as the wording reference he is seeking is not taken so he buys the rights for the term such as the wording reference, for a 5-year period. This term such as the wording reference “Ty Rant the ant” becomes his internet trademark, and what will be his item label or entity name in the knowledge system or database, as shown by 5b in FIG. 5. This is exclusive to Ty, as no one else in the world can use that item label or entity name. The top-level domain system sets up the structure for “Ty Rant the ant” being the item label in the item structure, as shown by method 20 as shown in FIG. 2. This set up is done in a top-level domain system database linked to Wikidata. Also, a Wikimedia page is set up for “Ty Rant the ant” with material and corresponding imagery to his item label or entity name. This material on Wikidata and Wikimedia help the knowledge system 5b in FIG. 5, to verify and reconcile the item label and corresponding material and imagery on the internet. “Ty's” item structure material is then verified and reconciled as part of the knowledge system as shown by 3b is FIG. 3 or as shown by 5b in FIG. 5. Following this, when a user of a search system enters the query “Ty Rant” and predictive text brings up “Ty Rant the ant” and the user clicks on that it becomes the search query as shown by 3f in FIG. 3. This query 3f is acted on by the search system as shown by 3e in FIG. 3, where a match in the knowledge system or database as shown by 3b in FIG. 3 is located. The search material is shown by 3g in FIG. 3, which is then presented in a knowledge panel as shown by 3h in FIG. 3. The knowledge panel as shown by 4d in FIG. 4 includes the item label “Ty Rant the ant” and corresponding imagery of “Ty” discussing the Bible. Additional material as shown by 4h in FIG. 4, in the knowledge panel as shown by 4d in FIG. 4, includes links to famous quotes. In time, “Ty” decides to create rolling public messages via the knowledge panel as shown by 4d in FIG. 4. “Ty” accesses his account as shown by 5e in FIG. 5, and uploads 50 jpeg images all relating to his item label “Ty Rant the ant”. All such images “Ty” had already listed on his Wikimedia page. The search system as shown by 5d in FIG. 5, then verifies and reconciles all of “Ty's” imagery as accepted in the knowledge system as shown by 5b in FIG. 5, or for example in a knowledge graph as shown by 5b in FIG. 5. After about 14 days “Ty” is notified in his account that all but 1 image, so 49 jpeg images, have been approved for display in a knowledge panel as shown by 4d in FIG. 4. Every Monday for the next 10 weeks “Ty” up-dates his corresponding imagery as shown by 5f in FIG. 5, to appear near his name in a knowledge panel as shown by 4d in FIG. 4. On each Monday when “Ty” selects the new imagery, such is up-dated in real time as shown by 5g in FIG. 5. When an internet user conducts a search on “Ty Rant the ant” each week, they get search results as shown by 5h in FIG. 5, of the same item label or entity name of “Ty Rant the ant”, but with new imagery that corresponds to that name. The corresponding imagery includes social product placement of bottles of “Coca-Cola”. “Ty” has a website “tyranttheantviews.com” and up-dates that website to correspond to material that will be presented in a knowledge panel as shown by 4d in FIG. 4. Throughout the rolling up-dated imagery “Ty” presents in the knowledge panel as shown by 4d in FIG. 4, and website, a unified consistent theme to the public of inclusion, acceptance and compassion. This creates a cross-pollination of messaging as shown by 5i in FIG. 5. In this way “Ty” engages the public with contemporary messaging in a lively, fluid, and inclusive way, with unified messaging that echoes across multiple platforms at the same time.

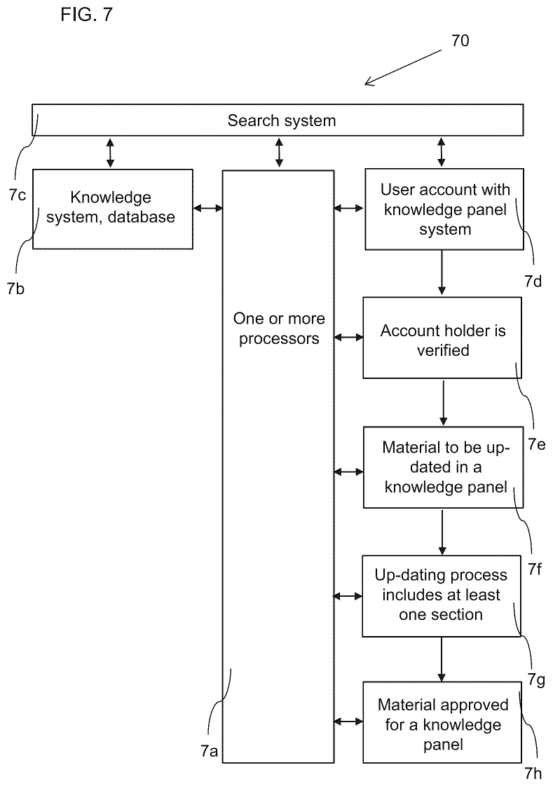

FIG. 7 shows a schematic diagram of an aspect of the invention, being a computer implemented method 70. This method includes one or more processors 7a, including one or more computers connected to the internet via one or more servers in the computing system 70. There is a knowledge system or database 7b, which includes a knowledge graph which includes items or entities connected. There is a search system 7c, which can include a search engine with servers and search capabilities including of the internet and knowledge system 7b. 7d shows the method where a user has an account with a knowledge panel system which in this example is part of the search system 7c, that produces knowledge panels as a result from users doing searches. The method 7e shows the account user is verified. This means the user has had credentials checked to verify the user has the right to edit the knowledge panel. Verification can include any applicable steps, such as via a username and password check, or further such as verifying photo identification such as a driver license being held up to a user's face when a photo is taken to ascertain a match of the user face with face in the license. Any other applicable verification steps can be taken as shown by 7e. The user submits material to up-date for their knowledge panel, such as item name, 7f being at least one section to up-date 7g. As an example, the user “Coca-Cola” applies to up-date the item label from “Ice Cold Refreshment” to “Feeling the Refreshment”. In yet other embodiments further sections can be up-dated at once, such as item imagery, and position of item domain name in list order, or anything else 7f. In this current example, as the user only applied to have one section up-dated 7g, it is up-dated by the knowledge panel system in a streamline way, which occurs in the time frame of between real time and 3-7 days. The material being up-dated is available to be verified in the knowledge system 7b, such as being an item on Wikidata and or on Wikimedia. In this way, a user can log onto their account 7d, of the knowledge panel system 7c, being part of the search system 7c, and up-date material efficiently. The knowledge panel system 7c approves and makes public in a search that produces results of “Feeling the Refreshment” in a respective knowledge panel, in the time frame of between real time a 3-7 days. This short time frame to up-date material or data means that a user can rely on more real time material or data being made public, as opposed to a system that take for example 7-14 days to approve.

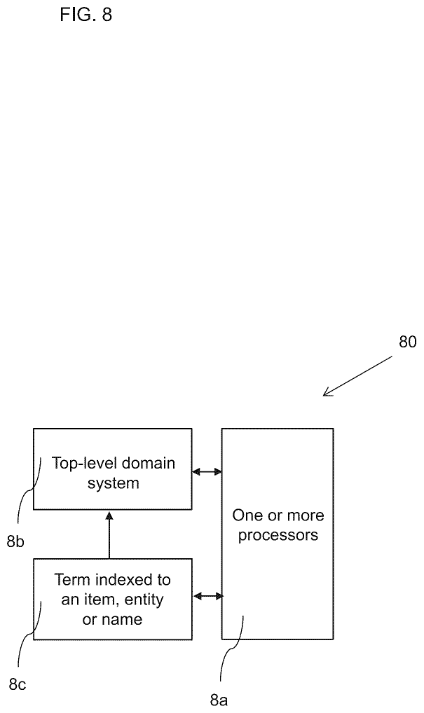

FIG. 8 shows a schematic diagram of an aspect of the invention, being a computer implemented method 80. This method 80 shows one or more processors 8a, such as being either a single computer with its internal connections, and or multiple computers and servers connected to the internet. This method 80 includes a method of a system 8b, being a top-level domain system, or what could generally be called a top-level wording domain system, that includes a database of a term such as wording indexed to an item, entity or domain, 8c, that can include a unique identifier. This method 80 works as a top-level domain system such as a top-level domain wording system in that a domain name such as “coca-cola .com” can be indexed to multiple sets of terms such as wording such as a) “Coca Cola” b) “Ice Cold Refreshment” c) “Zero Sugar” and d) “Feeling the Refreshment” d) or more terms such as wording sets. In this way when a user on the internet does a search on any of these terms or wording sets, such as “Ice Cold Refreshment” then the search results that come up will be the item of “Coca-Cola” in a knowledge panel and include at least the domain name “coca-cola .com”. The knowledge panel can include the term or wording set and domain name and other material about “Coca-Cola”. In this way, these terms or wording sets act as a top-level way of being directed to an item, or entity, a domain name, or any other thing with a unique identifier. In other examples of this method 80, the terms or wording sets can be indexed to an item unique identifier, so that the search results yield a list, and a knowledge panel with the term or wording set linked to the item unique identifier.

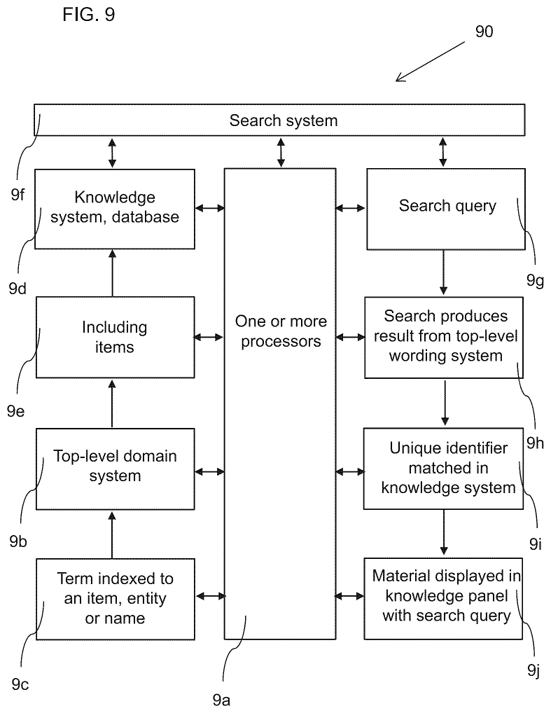

FIG. 9 is a schematic diagram of an aspect of the invention, being a computer implemented method 90. It includes the method of 80, and by this reference method 80 is included here with all parts and descriptions, as seen here as one or more processors 9a, top-level domain system 9b, and an index system or term such as wording indexed to an item, entity or domain 9c, which can include a unique identifier. 9d shows a knowledge system or database, such as a knowledge base or a knowledge graph, made up of items or entities 9e and links or edges connecting items or entities, and anything else relevant. 9f shows a search system, such as including a search engine with connection to knowledge graph 9d and facilities to compile and publish knowledge panels. At 9g an internet user inputs a search query. 9h shows results being produced. 9i shows unique identifier being matched in knowledge system 9d. 9j shows material being displayed in a knowledge panel with the search query 9g. By way of example a user inputs the query “Ice Cold” and with that predictive text brings up “Ice Cold Refreshment” so the user clicks on that 9g. 9h shows a search of the top-level domain system, such as the results that match being “Ice Cold Refreshment”. The top-level domain system term such as wording match links to item unique identifier, which links to unique identifier in knowledge system 9i. 9j shows material or item data retrieved from the knowledge system 9d and presented in the form of a knowledge panel 9j, but with the search query match 9j also presented in the knowledge panel either instead of the item label, or near the item label. In this way, a search for “Ice Cold Refreshment” will link to “Coca-Cola” in the top-level domain system as it is indexed to that, and in the knowledge panel the item label could appear as “Coca-Cola” “Ice Cold Refreshment” or as “Ice Cold Refreshment” that is the term such as a wording reference without the term “Coca-Cola”. Near the item label of course, is the item imagery which can co-operate with the item label or item label term such as wording, presenting a unified message or campaign.

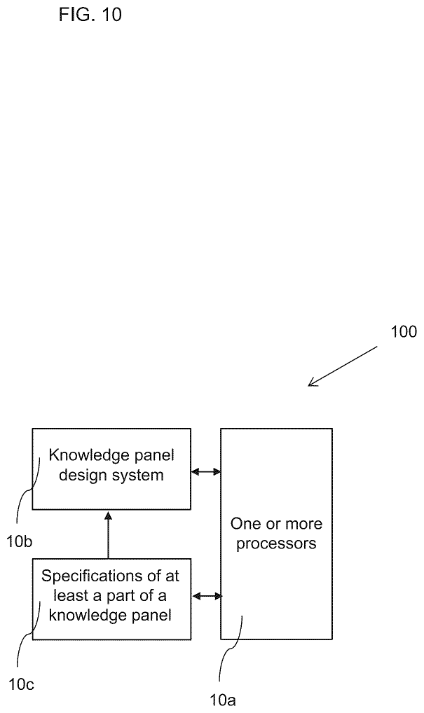

FIG. 10 shows a schematic diagram of an aspect of the invention, being a computer implemented method 100. This method 100 includes one or more processors 10a, and a knowledge panel design system 10b. This knowledge panel design system 10b includes at least a database of design specifications indexed to any or all of a knowledge panel 10c. In this way, the knowledge panel design system can have an account facility, where a user sets up an account, optionally gets verified, and can then go about editing the design specifications of their whole knowledge panel, or any part of it. For example, the knowledge panel design system 10b may allow an account user to design their item label only. In the case of “Coca-Cola” as a user, they may have the option to edit the item name of “Coca-Cola” to be replaced with the logo with the trademark ribbon look. In this way, the item label or entity name of “Coca-Cola” is in a trademark style which helps reinforce the message of the product which could be seen or connected to with the item imagery nearby in the knowledge panel. Alternatively, if a data file is not used for the design or appearance of the item label, and if text is used, then the account user may seek simply to have their item label in a bold font of their choosing, or a slightly different font size for a distinctive and unique look. In this aspect of the invention, variations of any or all of the design elements and principles of design can be drawn on, to help with the creative aspect of any part of a knowledge panel, or the whole knowledge panel, which helps communicate to an internet user, at least some material in a user designed format.

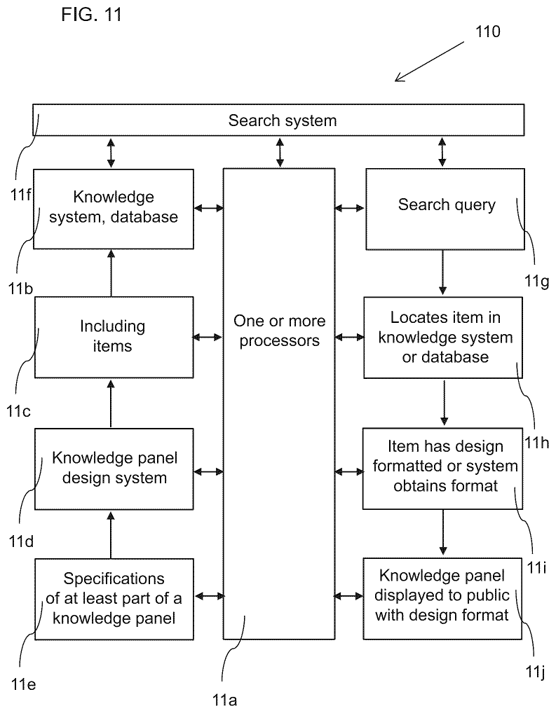

FIG. 11 shows a schematic diagram of an aspect of the invention, being a computer implemented method 110. This method includes the method 100 as described, and by this reference all the content and descriptions of method 100 are included here, as one or more processors 11a, a knowledge panel design system 11d, and design specifications for at least part of a knowledge panel 11e. 11b shows a knowledge system or database, including items or entities 11c, connected by links or edges from the perspective a being a knowledge graph 11b. 11f shows a search system such as a search engine with user accounts being connected via the internet. 11g shows a search query. 11h shows the search query matched term such as wording has been found in a knowledge system or database 11b. 11i shows that the material in the knowledge system or database 11b is either formatted with all design specifications 11e as indexed in the knowledge panel design system 11d, or the specifications are checked in the knowledge panel design system 11d, and any changes are made to the material design format to meet the design specifications to be presented 11i. 11j shows that the knowledge panel displays the item material to the design specifications as set out in the knowledge panel design system 11d. By way of example, a user of “Coca-Cola” may log onto their account in with the knowledge panel design system 11d and specify the design of the item label. For example, with the item label “Ice Cold Refreshment”, the user specifies the colour of the font to be red, and in the standard font used by Google for the Google Knowledge Graph, or as used by Microsoft for Microsoft Bing. By way of example, when an internet user does a search on “Ice Cold Re” and predictive text brings up “Ice Cold Refreshment” and the user clicks on that, search material is brought up in a knowledge panel with the item label “Ice Cold Refreshment” to design specifications 11e, with the item details being those used for the item “Coca-Cola”. Alternatively, a user of “Coca-Cola” may log onto their account with the search system 11f if the knowledge panel design system 11d is integrated directly with that, and may do edits from there. In other embodiments, the design specifications 11e could include content or data of any type or form to be included into the knowledge panel 11j, and or there could be design specifications set for or text, or any material.

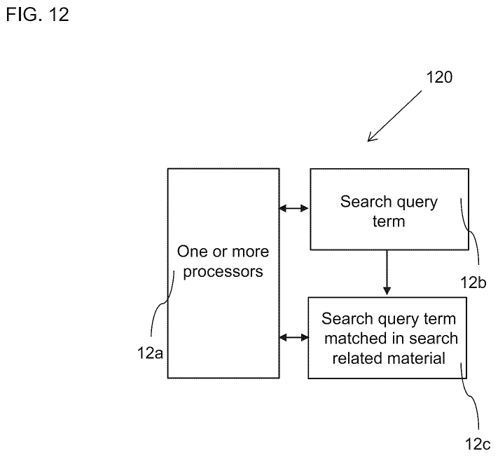

FIG. 12 shows a schematic diagram of an aspect of the invention, being a computer implemented method 120. 12a shows one or more processors. 12b shows a search query term. 12c shows search query term matched in search related material which includes search results. By way of example, in this way, when a user does a search on “Ty Rant the Ant” 12b, and a search is performed, search related material is presented in a knowledge panel, with the term “Ty Rant the Ant”, which is the matched term 12c. In this way, the repetition of the search term 12b helps emphasise to the user that there is a direct connection between the search query 12b and the results, by the matched term 12c, where the same search term 12b, is in the results presented 12c. This helps gives reassurance and affirmation to the user that the search query 12b has been listened to and heard, with feedback and confirmation 12c.

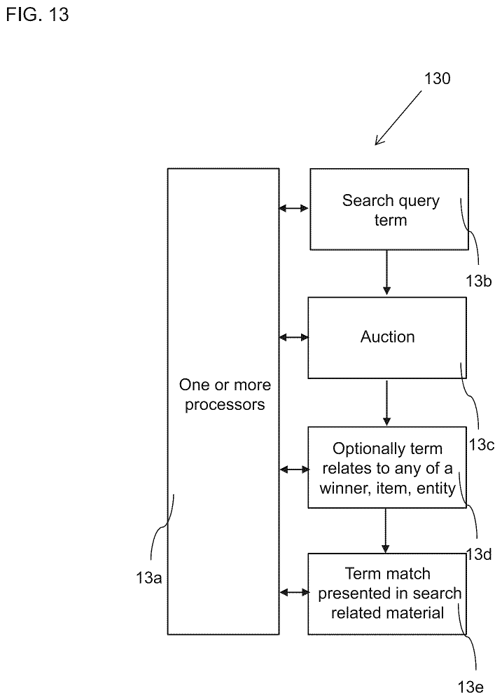

FIG. 13 shows a schematic diagram of an aspect of the invention, being a computer implemented method 130. 13a shows one or more processors. 13b shows search query term. 13c shows the process of the term 13b being auctioned. 13d shows process of search term 13b optionally being related to auction winner, and or knowledge system item, and or knowledge system entity. 13e shows term 13b match presented in search related material which includes search results. By way of example, in this way, when a computer user does a search on “Luxury Hotels New York” the term 13b is put to auction to a list of signed up hotel parties. The auction 13c can be in real time or held in any timeframe. In this example, the “Ritz-Carlton New York, Central Park” wins the auction which shows the search term 13b is related to the auction winner 13d, and item and entity 13d. The search term 13b is displayed with the search material such as including search results 13e so for instance in a knowledge panel of the “Ritz-Carlton New York, Central Park”, the search term 13b and match to that 13e is presented in the knowledge panel. This means the knowledge panel 13e includes the “Ritz-Carlton New York, Central Park” and below that the term “Luxury Hotel New York” 13b and 13e. In other examples, the search term 13b and match to that 13e can be above the item label or next to the item label, instead of the item label, or anywhere in the knowledge panel 13e.

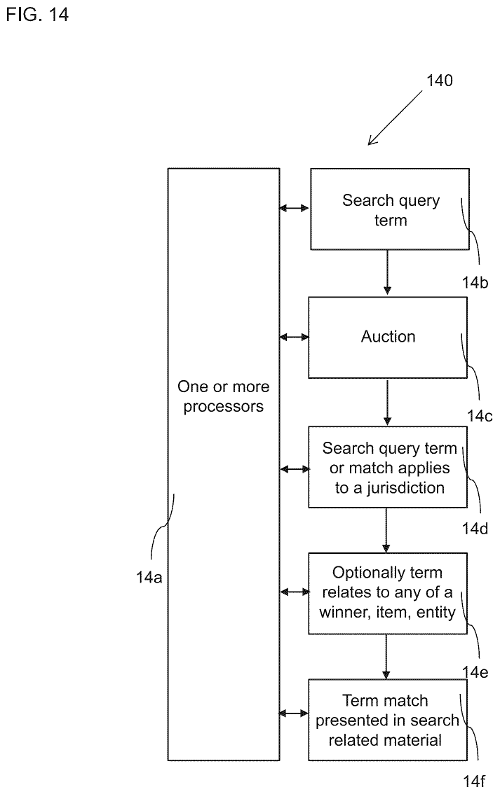

FIG. 14 shows a schematic diagram of an aspect of the invention, being a computer implemented method 140. 14a shows one or more processors. 14b shows search query term. 14c shows the process of auctioning the search term 14b. 14d shows search query term 14b or match, applies to a jurisdiction. 14e shows term 14b relates to auction winner and or knowledge system item, and or knowledge system entity. 14f shows the search term 14b or match to that presented in search related material which includes search results. By way of example, in this way, when a computer user does a search on “Friendly Hotel” this term 14b is auctioned in real time (and in other examples the auction could occur in any time frame). The query 14b is made by a user from “The Upper West Side, New York” which is within 100 km radius of Manhattan as the jurisdiction 14d. “The New Yorker Hotel” wins the auction, and so the term 14b is related 14e to the auction winner and item in a knowledge system or database. The computing system presents a knowledge panel of the search material 14f with the search term 14b matching at least a part of the search material 14f as “Friendly Hotel”. So, in the knowledge panel it includes “The New Yorker Hotel” and under that is “Friendly Hotel”. In this way the search query 14b is matched in the search results and linked to a “Friendly Hotel”, which could be interpreted as a trademark or service mark of “The New Yorker Hotel”.

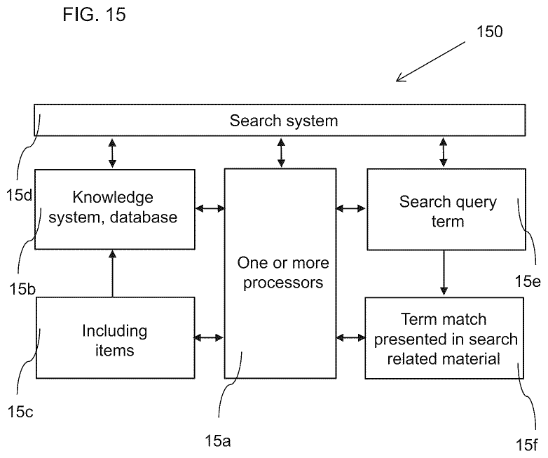

FIG. 15 shows a schematic diagram of an aspect of the invention, being a computer implemented method 150. 15a shows one or more processors. 15b shows a knowledge system or database. 15c shows process of items or entities being part of the knowledge system or database 15b. 15d shows a search system. 15e shows a search query term. 15f shows search query term matched in search related material which includes search results. By way of example, in this way, a computing system 150 user inputs a search query “5 Star Hotel” 15e. The search system 15d, including the Google search engine and knowledge system 15b also called a knowledge graph 15b, computes the search query “5 Star Hotel” and finds a match in the database 15b related to the knowledge graph 15, of the owner of that search term 15e held by “The Peninsula New York”. The search system Google 15d presents search related material including search results 15f with “5 Star Hotel”. In this way the knowledge panel includes item label or entity title as “The Peninsula Hotel” and under that is “5 Star Hotel” 15f. The matched term 15f serves as what could be interpreted as a trademark or service mark for “The Peninsula Hotel” and establishes a direct link between the search query 15e and the search related material including search results in the knowledge panel 15f. In this way the term “5 Star Hotel” acts as a top-level domain name, a system of directing a user from a search query 15e to the landing pad of the search result 15f. In this way a knowledge panel could be considered like a new form of website or similar to that, such as a thumbnail of a website, or introduction to a website, or similar to that. In this way, this system is a new type of top-level domain for the knowledge panel website leading from the search query term 15e which is matched in the knowledge panel 15f.

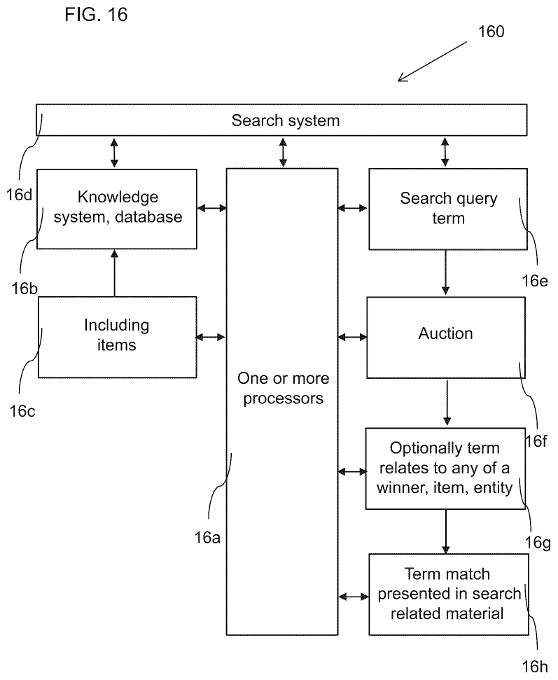

FIG. 16 shows a schematic diagram of an aspect of the invention, being a computer implemented method 160. 16a shows one or more processors. 16b shows a knowledge system or database. 16c shows items or entities being included in the knowledge system or database 16b. 16d shows a search system. 16e shows a search query term. 16f shows an auction process. 16g shows process of optionally search term 16e being related to the auction winner and or item and or entity in a knowledge system 16b. 16h shows search term 16e match in search related material which includes search results. By way of example, in this way, a computing system user in Norway inputs a search query of “Manhattan Hotel” 16e which is then put to auction to a list of signed up hotels for auction process. The winner is the “Ritz-Carlton New York, Central Park”. The hotel does relate 16g to the search query 16e. The search system 16d, Microsoft Bing, searches its knowledge system, or knowledge graph, 16b, and produces the search material of a knowledge panel 16h that includes “Manhattan Hotel” 16e. In this way, in the knowledge panel is “Ritz-Carlton New York, Central Park” and below that is “Manhattan Hotel” 16e and 16h. This shows a method where the auction winner is able to link their name, or item label or entity title, to the search query 16e. That process can allow the search term 16e to act as a trademark or service mark for the item or entity 16g, or similar type of positive affirmation process by a match of the exact search query 16e that the user is looking for, and where the search term 16e is positively relayed in the search results 16h.

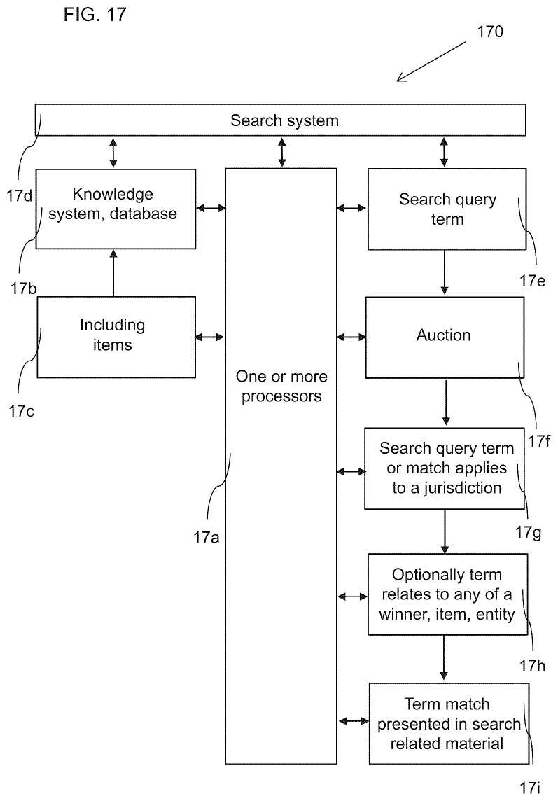

FIG. 17 shows a schematic diagram of an aspect of the invention, being a computer implemented method 170. 17a shows one or more processors. 17b shows a knowledge system or database. 17c shows including items or entities. 17d shows a search system. 17e shows a search query term. 17f shows process of being auctioned. 17g shows process of search term 17e applying to a jurisdiction. 17h shows optionally the search term 17e relating to the auction winner and or item and or entity in a knowledge system 17b. 17i shows search query term 17e being matched and presented in search related material including search results. By way of example, in this way, a computing system user located in “Wall Street Manhattan”, being in the jurisdiction of 50k radius of “Manhattan CBD”, places search query of “Luxury Hotel” 17e. (In other embodiments, the search query term and or matched term to that applies to any jurisdiction, which can include any geographical jurisdiction being made up of any number of places, which can include any of: a town; and or a city; and or a state; and or a country; and or more than one country; and or a continent; and or more than one continent; and or across the world). The term 17e is put to auction in real time. There are 45 hotels in “New York” ready to place live bids for use of the term 17e that link the term 17e to their hotel in the search related material including results. In this case “The Peninsula” wins the bidding and as a 5 Star hotel that is related to the search term 17e. The search system 17d Google locates material and data from the knowledge system 17b, the knowledge graph 17b. Search related material is presented in the Google knowledge panel 17i with the term 17e matched 17i. The knowledge panel includes “The Peninsula” and above that is “Luxury Hotel” 17e and 17i. This shows how a person in “Wall Street” can be directed to a luxury hotel in “New York”. This process displays how the term “Luxury Hotel” can be exclusively linked to a hotel applying withing the jurisdiction of a given city. In this way different cities around the world can simultaneously link to the same term 17e to a different items or entities 17h. In this example, the search term 17e is echoed in the results 17i, where the search result match term 17i is a fractal of the search term 17e. This helps affirm to the customer reassurance of the search related material by demonstrating the natural process of fractals, that are organically present in nature.

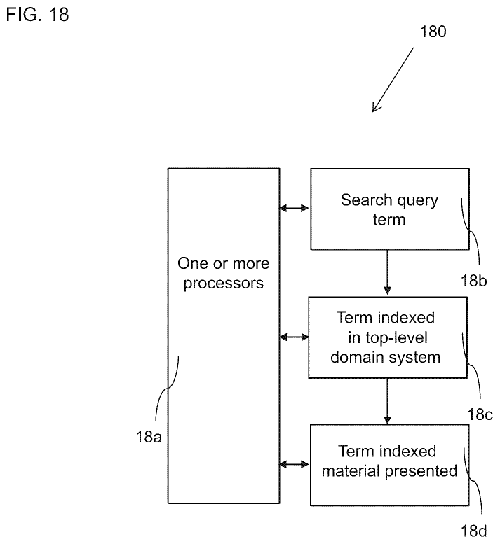

FIG. 18 shows a schematic diagram of an aspect of the invention, being a computer implemented method 180. 18a shows one or more processors. 18b shows search query term. 18c shows search query term 18b indexed in a top-level domain system. 18d shows term indexed material presented in search related material which includes search results. By way of example, this computing method 180 shows a computer user inputs search query of “Classic Hotel” 18b. The top-level domain database indexes the term “Classic Hotel” 18b to an item or entity as part of a knowledge system or knowledge graph. In this example, the item label is “The Plaza” hotel, with related item material in the knowledge system. In this way, when search material is retrieved on “The Plaza” to present in search results 18d, the indexed material to “The Plaza” hotel includes “Classic Hotel” 18b. In this way, in a Google knowledge panel, included is the item label “The Plaza” and below that is “Classic Hotel”. In other examples, the indexed term “Classic Hotel” 18b could become the item label or entity name. These example processes show how the search term 18b becomes a top-level domain system, or a knowledge panel domain name system, for search material about “The Plaza”, that can include a domain name, photos and more. This method of search terms 18b being domain directors, can also be called panel domains, as in knowledge panel domains.

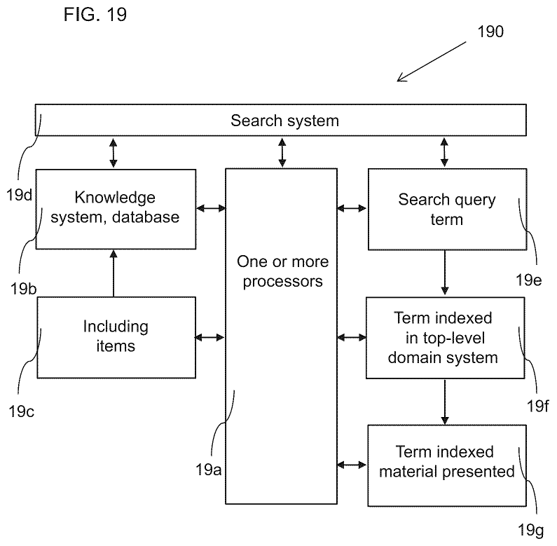

FIG. 19 shows a schematic diagram of an aspect of the invention, being a computer implemented method 190. 19a shows one or more processors. 19b shows a knowledge system or database. 19c shows including items or entities. 19d shows a search system. 19e shows a search query term. 19f shows search term 19e indexed in top-level domain system. 19g shows search term indexed material presented in search related material. By way of example, this displays how a computing system 190 user applies a search query 19e in a search system 19d Microsoft Bing. The search query term 19e is “Historic Hotel New York” made by a user in Finland. The term 19e is applied in an index in the top-level domain system, linked to “The New Yorker Hotel”. This indexing is done in real time, based on a search of the Microsoft Bing knowledge graph revealing the item of “The New Yorker Hotel” applies to “Historic Hotel New York” (in other embodiments the item that would receive the search term 19e to be indexed to, can be via an auction process, or by any other process). In this way, when search related material is presented 19g such as a knowledge panel, the search term 19e that is indexed to “The New Yorker Hotel” is presented in the knowledge panel. The displayed search results include “The New Yorker Hotel” and “Historic Hotel New York”. The term indexed material 19g includes “Historic Hotel New York” indexed to “The New Yorker Hotel”. This shows how the search results presented 19g include “Historic Hotel New York” which is a fractal of the search query term 19e. As fractals occur in nature, this fractal process in the search process and results presentation, links a fundamental aspect of nature to the process of an item being indexed, in this case, “The New Yorker Hotel” with a search term 19e and it being present as self-similar in the presentation 19g.

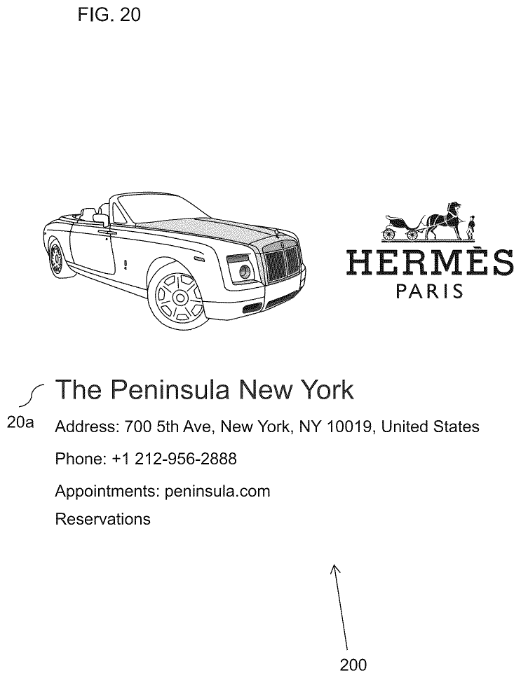

FIG. 20 shows a schematic diagram of an aspect of the invention, being a computer implemented method 200, in the form of a knowledge panel. In relation to FIGS. 1-19, the item label, or entity title, search query term, matched term, and or indexed term referred to, correspond to 20a, in this FIG. 20.

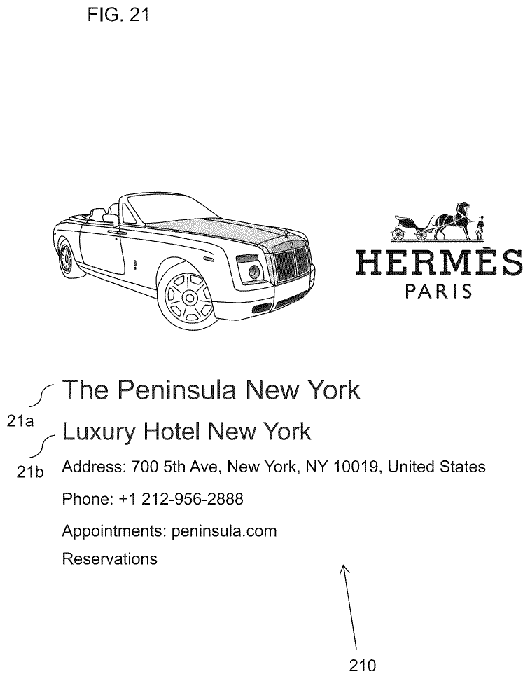

FIG. 21 shows a schematic diagram of an aspect of the invention, being a computer implemented method 210, in the form of a knowledge panel. In relation to FIGS. 1-19, the item label, or entity title referred to, correspond to 21a in this FIG. 21, and the item label term such as a wording reference, or entity title term such as a wording reference, search query term, matched term, and or indexed term, referred to in FIGS. 1-19, correspond to 21b, in this FIG. 21.

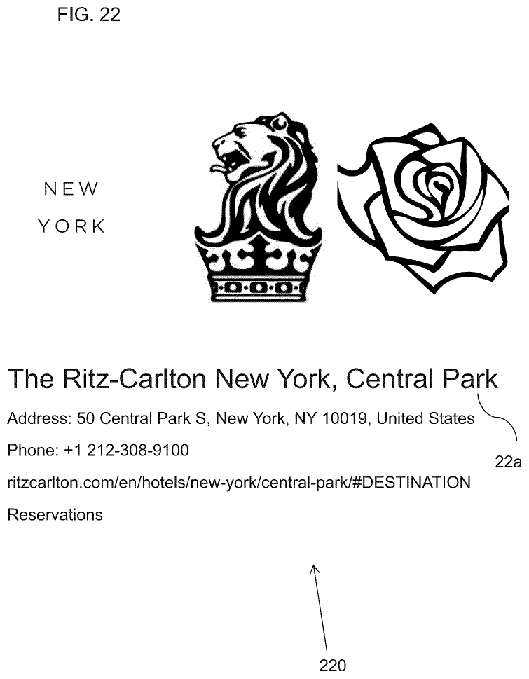

FIG. 22 shows a schematic diagram of an aspect of the invention, being a computer implemented method 220, in the form of a knowledge panel. In relation to FIGS. 1-19, the item label, or entity title, search query term, matched term, and or indexed term, referred to, correspond to 22a, in this FIG. 22.

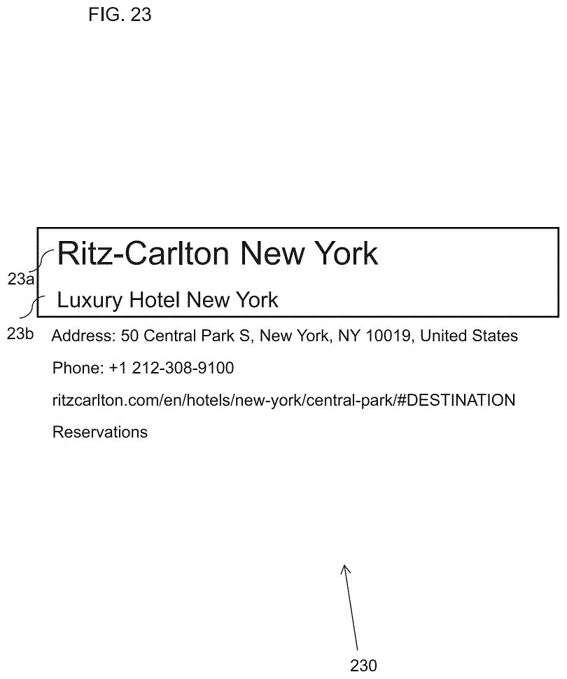

FIG. 23 shows a schematic diagram of an aspect of the invention, being a computer implemented method 230, in the form of a knowledge panel. In relation to FIGS. 1-19, the item label, or entity title referred to, correspond to 23a in this FIG. 23, and the search query term, matched term and or indexed term referred to in FIGS. 1-19, correspond to 23b, in this FIG. 23.

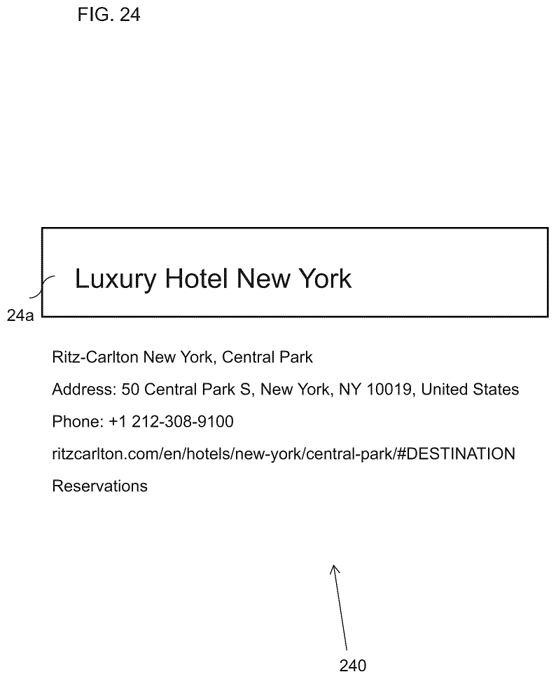

FIG. 24 shows a schematic diagram of an aspect of the invention, being a computer implemented method 240, in the form of a knowledge panel. In relation to FIGS. 1-19, the item label, or entity title, search query term, matched term and or indexed term referred to, correspond to 24a, in this FIG. 24. In an example, an item has the item label, or an entity has the entity title, “Luxury Hotel New York” linked to the “Ritz-Carlton New York, Central Park” in a knowledge system. Alternatively, in another example, the search query term “Luxury Hotel New York” is linked to the “Ritz-Carlton New York, Central Park” in a knowledge system. Alternatively, in another example, “Luxury Hotel New York” is indexed to the “Ritz-Carlton New York, Central Park” in a top-level domain system.

In relation to FIGS. 20-24 each knowledge panel is shown by way of representation, and in actual use on a computer screen the knowledge panel can be of any size, format, or position, including where a search result list may also be visible when a knowledge panel is visible.

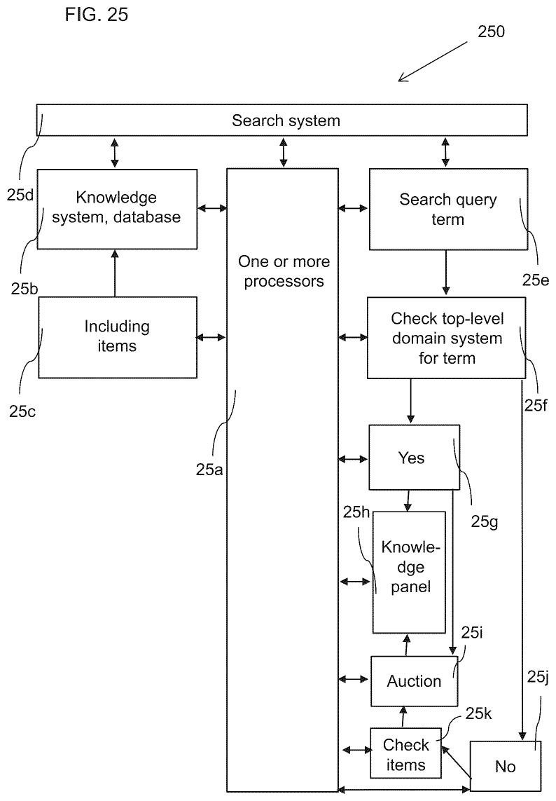

FIG. 25 shows a schematic diagram of an aspect of the invention, being a computer implemented method 250. 25a shows one or more processors. 25b shows a knowledge system or database. 25c shows including items. 25d shows a search system. 25e shows a search query term. 25f shows process of checking top-level domain system for term. 25g shows “Yes” indicating that the search query term is indexed in a top-level domain system. 25h shows one or more search engines presenting a knowledge panel. This is done by one or more search engines interacting with the top-level domain system, locating the search query term 25e in the top-level domain system, then locating the indexed material to the term, which is at least a unique identifier to an item or entity. The one or more search engines look up the unique identifier in the knowledge system or database 25b, corresponding to an item or entity. retrieve content, format that and present 25h the search related material in a knowledge panel with the search query term 25e included. 25i shows an auction process, which can be in any time frame, including real time. The auction process 25i from the “Yes” 25g shows that an account user has a term registered in the top-level domain system, and indexed to a unique identifier, they can manage through their account settings, to auction out, or hire out their term which is then bid on in the auction 25i by respective potential hirers to be used in relation to another unique identifier, that is, a different unique identifier to that which the term 25e originally corresponds to, or is indexed to. 25j shows “No” which means the search query term 25e is not indexed in or part of the top-level domain system. Following the outcome of “No” for the top-level domain system 25j, the search system 25d then checks 25k the knowledge system or database 25b to see if the term 25e is indexed to an item label or not, such as being an item label. When the term is not an item label 25k the outcome for that is also “No” which leads to 25i, the auction process, which can occur in any time frame, including in real time. The winner of the auction gets to allocate where the search query term 25e is presented. The winner allocates the search query term 25e to be presented by one or more search engines 25d in a knowledge panel 25h, which can be linked to or connected to a given item or entity, or presented in a knowledge panel 25h with no meaning to the content of the item or entity. By way of example, in this way, when a computer user does a search 25e of “5 Star Hotel New York” the search system 25d, such as any or all of Google, and or Microsoft Bing, and or Yahoo! (and or any other applicable search engines) interact with the top-level domain system 25f, and check if the term 25e is registered with the top-level domain system 25f. In this event the term 25e is processed at the check 25f and produces a “Yes” 25g. In this event, the respective search engine or search engines 25d, obtain the unique identifier, such as the Q identifier, indexed or corresponding to the term in the top-level domain system, and apply the found unique identifier to the knowledge system 25b. The respective search engine or search engines 25d locate the item or entity material related to the unique identifier, and format and present the knowledge panel 25h with the search query term 25e, being the term indexed to the unique identifier, or corresponding to the unique identifier, in the top-level domain system. In this example, the term “5 Star Hotel New York” is paid for and registered to the “The Peninsula New York” in the top-level domain system. In the respective knowledge panel 25h the item label is the “The Peninsula New York” and below that is the term “5 Star Hotel New York” which is a fractal of the search term 25e. When people see the process of a fractal in the search and display process it greatly helps with assurance and connection with material and content, as fractals occur in nature in the world around us, and this creates a connection of fractals occurring on computer and fractals occurring in nature. This can present that the fractal process occurring on computer is a fractal of nature, with the engagement of the user.

Continuing the description of FIG. 25, by way of example, when a user does a search 25e on “Holiday New York” the term is shown to be registered to an individual 25g as “Yes” in the top-level domain system. The individual has set their account settings to auction their term on a search-by-search basis, and accept the highest price for the rental or hire of their term 25e. The auction is in real time. There are 25 hotels in the auction. The process for live or real time auctions as used on the internet in any applicable way, can be used in this process herein. The highest bid comes in from the “Ritz-Carlton New York, Central Park” 25i. The payment is made from the “Ritz-Carlton New York, Central Park” to Yahoo!, and Yahoo! Pays the individual 50% of the total received by Yahoo! This is to share in the revenue made in a fair way. The term 25e has the original unique identifier in the top-level domain system. To allocate the temporary rental or hire of the term 25e various methods can be used. One such method is where temporarily the term 25e is indexed or linked, in the top-level domain system, to the auction winner. The search system such as Yahoo! 25d locates the unique identifier of the auction winner, and applies that in the knowledge system 25b and from there obtains item content corresponding to the unique identifier, and presents that in a knowledge panel 25h. Another way the temporary use of the term 25e can be linked or indexed to the auction winner 25i, is when there is the auction process, the settings for bidders include the unique identifier that will be allocated the term 25e in the event of an auction win 25i, and where such unique identifier is provided to the search system Yahoo! 25d. With the auction winner providing the allocated unique identifier, the search system Yahoo! 25d can apply that to the knowledge system 25b to locate search related material for a knowledge panel 25h. The search system Yahoo! 25d produces a knowledge panel 25h of the “Ritz-Carlton New York, Central Park” with the temporary term 25e “Holiday New York” positioned below the item label of the “Ritz-Carlton New York, Central Park”. The price paid by the auction winner can be paid in full to Yahoo! where 50% of that is kept by Yahoo! and 50% is paid to the term original owner or registrant. In other embodiments any applicable financial arrangement can be made between the search system 25d and the registered term 25e owner or registrant. In this way, the auction winner gets the advantage of having or allocating a new positive term or trademark or service mark, which can help the search and results display process, and the individual who is the term 25e registered owner or registrant, gets to share the use of their term and enjoy additional income, while an advantage for the search engine company Yahoo! 25d is that they get additional engagement in their search engine and display system, from users being the original term owner or registrant, and the auction bidders and winner, and item to whom term is allocated, and further, the search system 25d gets additional income from the auction process 25i.

Continuing the description of FIG. 25, by way of example, when a user inputs the search query term “Hotel” 25e the search system, Google 25d interacts with the top-level domain system and checks to see if the term “Hotel” 25e is registered or not in the top-level domain system. The search system 25d confirms the term 25e is not registered to an owner 25j, so a “No” is processed at 25j. The search system 25d checks 25k the knowledge system or database 25b to check if the term is indexed to an item or not there, for example as an item label. The search system 25d confirms the term 25e is an item label for the generic term hotel. As the search results for that, a knowledge panel is produced in the convention way for the item label “Hotel”. The user is still interested to find a specific hotel to stay, so keeps looking online. The under inputs “USA Hotel” as a search query 25e. The search system 25d Google checks the top-level domain system to see if that is registered 25f. It is not registered 25j so “No” is processes. The Google system 25d checks 25k the knowledge system or database to see if the term “USA Hotel” is an item label. The result is not 25k. On the basis the term is not already an item in the knowledge system or database 25b, the term 25e is put to auction in real time. There are 250 hotels across the USA that have accounts with settings set up with Google 25d, for bidding in auctions 25i for hotel related terms. The auction 25i is held in real time with the 250 hotels with auction accounts. The process for running the auction in real time is in accordance with known systems in the industry. The winner of the auction is “The New Yorker Hotel”. The winner of the auction 25i has the right to allocate, via its account settings, the term 25e and “The New Yorker Hotel” has set that to itself. The search system Google 25d locates the allocated unique identifier such as the Q identifier, at the auction winner account interface. The search system Google 25d applies the unique identifier to the knowledge system or database 25b and locates the item corresponding to the unique identifier, being “The New Yorker Hotel”. The search system Google 25d then obtains and presents the search related material of the item corresponding to the unique identifier, in the knowledge panel 25h on Google 25d search results page. The display of the knowledge panel 25h has the item label of “The New Yorker Hotel” and below that is the 25i auctioned 25e term being the search term 25e, of “USA Hotel”. In this way, a traveller searching online for a “USA Hotel” can be directed specifically and definitely to a hotel that buys the right to use that term, that is, have that term exclusively connected from the search query 25e, to be echoed in the knowledge panel 25h and be a panel domain. This process creates the advantage of helping a specific hotel stand out as a “USA Hotel” in a 100% accurate and definite way. This connection of the term 25e in the knowledge panel 25h is by way of being self-similar, a fractal. This shows how the term is connected via relationship, where the relationship is the term in the knowledge panel being a fractal of the search query term 25e. The fractal term in the knowledge panel 25h is seen to echo or follow after the first use of the term, being the search query term 25e.

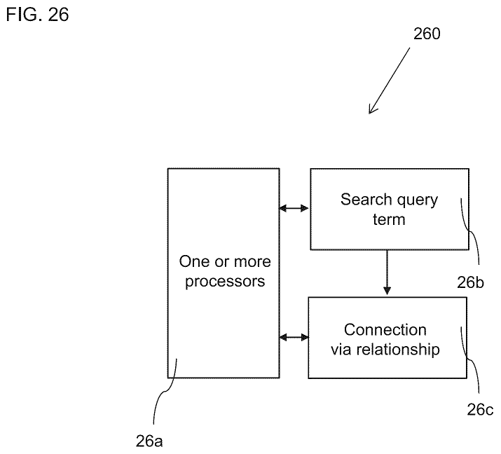

FIG. 26 shows a schematic diagram of an aspect of the invention, being a computer implemented method 260. 26a shows one or more processors. 26b shows a search query term. 26c shows connection via relationship. By way of example, in this way, a search term 26b in a computer implemented system 260, can lead to a connection via relationship 26c. This occurs where there is a connection of search related material including results, with the search query term 26b, being a term that self-similar or the same, present at the same time, in the search related material and the search query term. The relationship of the self-similar term is that of being a fractal. This is the process of connection via relationship 26c.

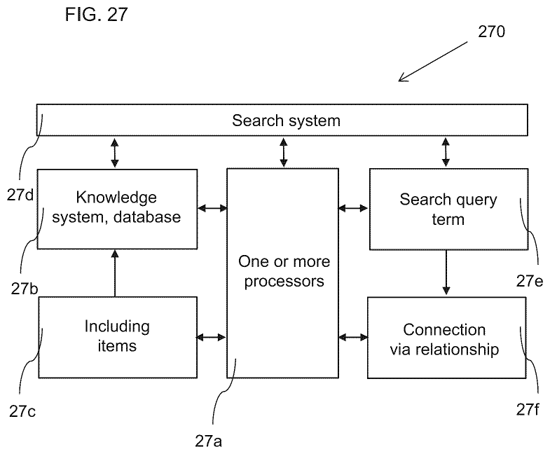

FIG. 27 shows a schematic diagram of an aspect of the invention, being a computer implemented method 270. 27a shows one or more processors. 27b shows a knowledge system or database. 27c shows including items. 27d shows a search system. 27e shows a search query term. 27f shows connection via relationship. By way of example, in this way, with a search term 27e such as “New York Hotel” in a computer implemented system 270, there can be a connection via relationship 27f. The search system 27d searches the top-level domain system for the term “New York Hotel” and finds the term is not registered to an owner. The search system 27d searches the knowledge system or database for term being an item label or not, or optionally indexed to an item. As the term 27e is not registered to anyone and is not indexed to an item, such as being an item label, the search system Bing 27d runs an auction of the term 27e. The winner of the auction is “The Peninsula New York”. Bing 27d obtains the unique identifier of “The Peninsula New York” and apples that to the knowledge system or database 27b and locates the corresponding item 27c. Bing formats and presents a knowledge panel that includes “The Peninsula New York” and above that the term “New York Hotel”. The connection occurs where the term “New York Hotel” in the knowledge panel is self-similar or the same, as the search query term 27e, whilst being present at the same time. The relationship of the self-similar term is that the term in the search results is a fractal of the search query 27e. This is a fractal system in process. This is the process of connection via relationship 27f. The process of the computer implemented method 270 creating a fractal system 27f gives a computer user an interactive connection with nature. This interactive connection with nature occurs as the computing system 270 provides for input of the search query term 27e from a user, which is then echoed in the search related material, where the term there is a fractal of the search term. This shows the user helped create a fractal in the search related material. As fractals occur in nature, and this fractal process occurs on a computing system 270, the user is connected to nature by the process of the fractal process occurring on the computing system 270, and in the world around us at the same time. In itself this process can be seen as the computing system 270 with the connection via relationship 27f being a fractal of nature.

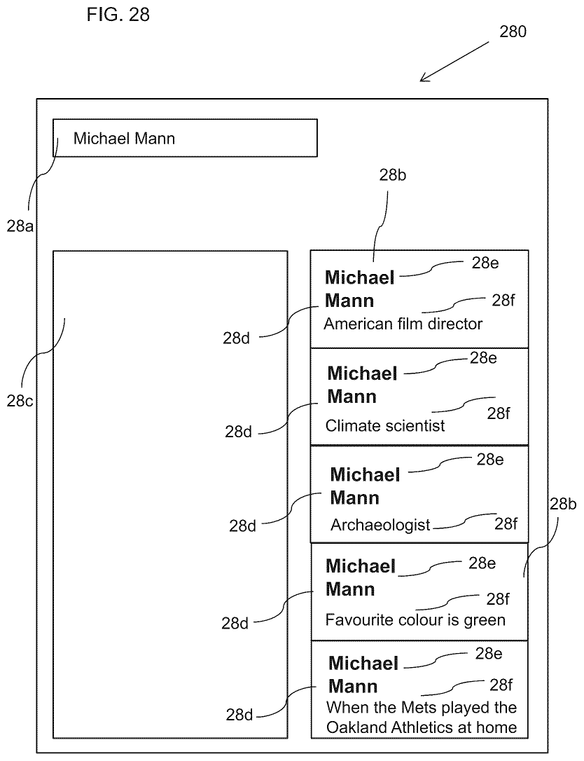

FIG. 28 shows a schematic diagram of an aspect of the invention, being a computer implemented method 280. This method 280 is in the form of a search engine browser on a computer screen. 28a shows a search term. 28b shows a panel or a knowledge panel, with multiple results 28d to the search term “Michael Mann”. 28c shows the area for search results in a list format, usually with sponsored links at the top section of the list. 28e shows the search term search result of a first term being “Michael Mann”. 28f shows the second term in relation to each of the first terms 28e. 28d shows the composition of the first term 28e and the second term 28f together, forming the term 28d. The whole term 28d can be an example of how the combined terms 28e and 28f are registered and saved in a panel domain database. By way of example, in this way the first term 28e is a fractal of the search term 28a. When a user does a search on a search term, such as “Michael Mann” 28a on Microsoft Bing search engine 280, when there are multiple people with that name 28e, a panel or knowledge panel 28b is displayed representing each individual person by the first term of their name 28e, and the second term of further material about each person 28f, such as relating to interests, skills or aptitude. The search of 28a initially searches the database for 28a “Michael Mann” and brings up the term 28d, being the first term 28e and second term 28f. The computer user of the method 280 can read the list of people in the panel or knowledge panel 28b, and select the one they think they are looking for, by clicking on the selected person 28d to be directed to a dedicated knowledge panel on the selected person. The second term 28f can be made up of between 1-10 terms, that can embellish details about the first term 28e. With this system 280, if two or more people have the same first term 28e, and the same or similar second term 28f, then there is the option for either of them or all of them to further detail the second term 28f to bring the overall term 28d to become more idiosyncratic or unique by the creative use of the second term 28f. With this system 280, there can be any number of terms 28f that follow the same first term 28e, where the overall term 28d can be differentiated, or distinguished from other terms 28d, by further information or referencing by use of the second term 28f. In this way, each individual person, or company, or entity, or item, or aspect or thing can have their own unique knowledge panel that can be uniquely distinguished from others. Each entity represented by the term 28d has an account with a panel domain service where they pay an annual amount for the license of their term 28d. In summary, two or more people may be very similar in a lot of ways, but there will always be at least some point of difference, and such point of difference can be integrated into the second term 28f, or instilled in the second term 28f, or represented in the second term 28f, to create a unique whole term 28d.

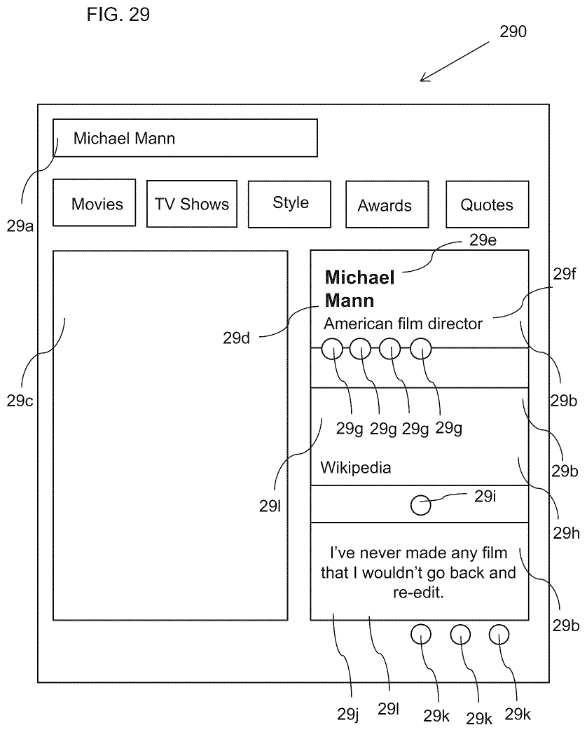

FIG. 29 shows a schematic diagram of an aspect of the invention, being a computer implemented method 290. This method 290 is in the form of a search engine browser on a computer screen. 29a shows a search term, and in this example is “Michael Mann”. 29b shows a knowledge panel. 29c shows the area for search results list, that usually include sponsored links at the top section. 29d shows the term being the item label or entity title, and in this example is “Michael Mann American film director”. This screen and method 290 can be arrived at after a user clicking on the respective term indexed in list, and in this example is “Michael Mann American film director” in the screen 280 (FIG. 28). This term 29d is made up of the first term, and in this example is “Michael Mann” 29e and the second term, and in this example is “American film director” 29f. The term 29d is a top-level domain system and is indexed to a unique identifier in a panel domain database. The unique identifier, in this example is “Michael Mann American film director” is indexed in the search engine knowledge graph, so that the top-level domain system becomes the item label 29d in the knowledge panel when the content is obtained from the knowledge graph to fill the knowledge panel 29b. The entity represented by the term 29d has an account with a panel domain service where they pay an annual amount for the license of their term 29d. 29g shows icons for links such as Wikipedia, Twitter, Instagram and Facebook. 29h shows content that is verified and presented from a neutral point of view, which in this example is Wikipedia. 29i shows an icon to see more material or view more material below the Wikipedia section 29h. 29j shows a section that is a post from the user, and in this example is “Michael Mann” wherein the post is of a quote presented from a first-person point of view, and wherein the quote is verified. The verification process means the quote is part of the search engine knowledge graph, and is verified as such. 29k shows icons that relate to the post, and can include anything, such as “Like”, “Share” and “Views”. 29l shows the social media system of material presented from a neutral point of view 29h together with current material in a post 29j being of verified content from a first-person point of view. By way of example, in this way, when an entity (28d in FIG. 28) is clicked on from a summary list of “Michael Mann” people and taken to a knowledge panel 29b in FIG. 29, the term 29d is a top-level domain system. This means the top-level domain system is indexed to a unique identifier in a panel domain database, and the unique identifier is indexed in the search engine knowledge graph to content that is to be displayed and formatted in a knowledge panel 29b. Once the unique identifier is located in the panel domain database from a term search 29d, it is looked up in the search engine knowledge graph to locate material indexed to the unique identifier, to then present located material in a knowledge panel of the term or subject 29d. The social media system 29l is comprised of 100% verified content, and where such content is accepted as part of the search engine knowledge graph. This social media system 29l creates a cross-pollination of material being content presented from a neutral point of view from Wikipedia 29h, and to contrast and complement that, there is a current post 29j that is of a current or past time frame quote by the item or person who has the knowledge panel 29b. This social media system 29l has the advantage of presenting reliable material, that is where it is all verified and part of a knowledge graph in a search engine, but with the advantage that the entity who has the knowledge panel 29d, can make a real time post, share or comment, yet with the same very high level of trusted source material. By way of further example, the post section 29j can have a hyperlink embedded in that to direct a click on that to go to the source of the post, such as a quote from an interview, or a video in the event of a video interview. In other examples, the post may come from any verified source, which can include being from a book, a magazine, a discussion, a meeting, a party, a sport game, or anything else. An advantage of having a post 29j by the knowledge panel user 29d, as opposed to a quote selected from a search engine company, is that the knowledge panel user 29d can choose to emphasise what to post, and to do so when they choose to do it, enacting a sense of control and contact with viewer. In traditional systems where a knowledge panel includes a quote from a knowledge panel user for example, the overall content can appear listless and planar as there is no direct contact with the knowledge panel user 29d and the viewer. In that case, it is as if there is a veneer between the knowledge panel 29b and the viewer. However, a current post 29j from a user 29d creates a sense of engagement with viewers, by a viewer reading or seeing a post 29j, that complements the knowledge panel 29b material and content, creating a sense of life and unity with the overall composition of the knowledge panel 29b material.

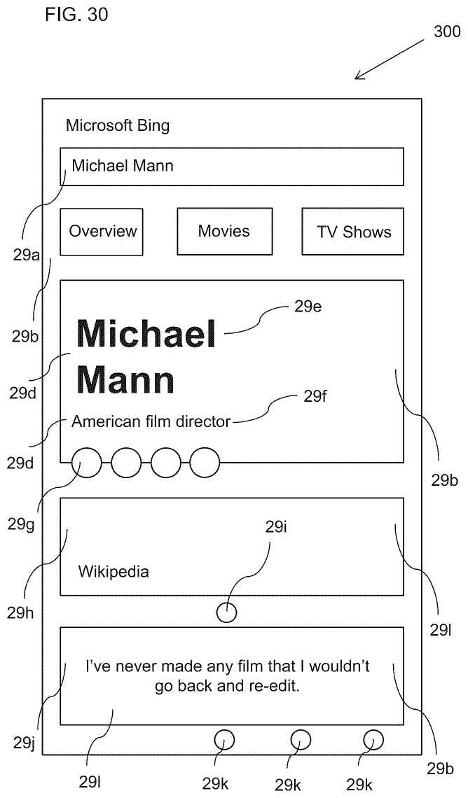

FIG. 30 shows a schematic diagram of an aspect of the invention, being a computer implemented method 300. This method 300 is in the form of a mobile phone screen and display of a search engine browser. All the applicable FIGS. 29a-29l with descriptions in FIG. 29 also apply to this FIG. 30.

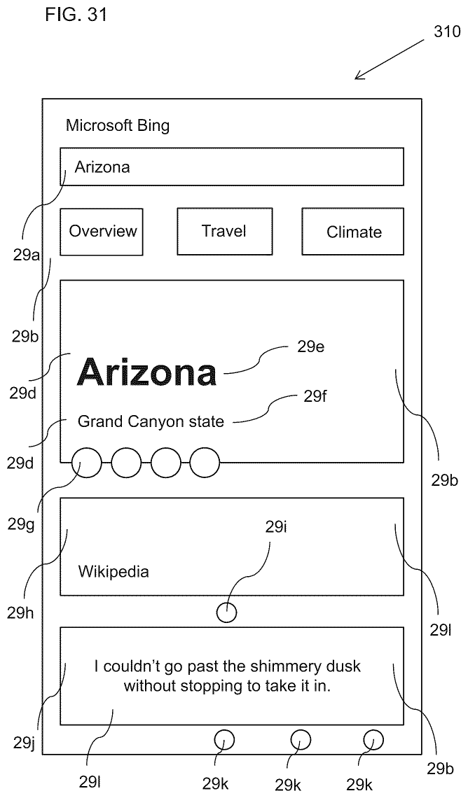

FIG. 31 shows a schematic diagram of an aspect of the invention, being a computer implemented method 310. This method 310 is in the form of a mobile phone screen and display of a search engine browser. All the applicable FIGS. 29a-29l with descriptions in FIG. 29 also apply to this FIG. 31, taking into account that in this FIG. 31 there are the following interchangeable examples where, 29a is “Arizona”, and 29d is “Arizona Grand Canyon state”, and 29e is “Arizona”, and 29f is “Grand Canyon state.”

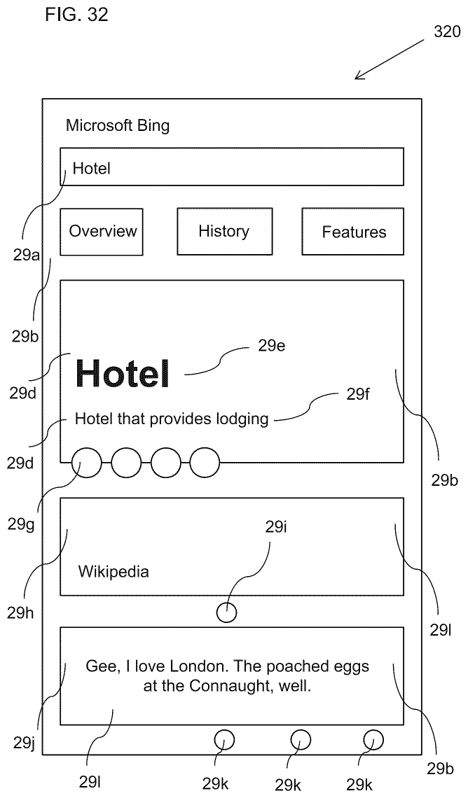

FIG. 32 shows a schematic diagram of an aspect of the invention, being a computer implemented method 320. This method 320 is in the form of a mobile phone screen and display of a search engine browser. All the applicable FIGS. 29a-29l with descriptions in FIG. 29 also apply to this FIG. 32, taking into account that in this FIG. 32 there are the following interchangeable examples where, 29a is “Hotel”, and 29d is “Hotel Hotel that provides lodging”, and 29e is “Hotel”, and 29f is “Hotel that provides lodging”. In this FIG. 32, the top-level domain system 29d can occur in various different ways. One is as “Hotel Hotel that provides lodging” where this term 29d is indexed to the unique identifier of “Hotel Hotel that provides lodging” in a panel domain database. That unique identifier “Hotel Hotel that provides lodging” is looked up in the search engine knowledge graph to obtain the material indexed to that in order to display such indexed material in a knowledge panel 29b. Based on the search term 29a of “Hotel” that would bring up an index of results including “Hotel” as a term 29e to choose from (like method 280 in FIG. 28). The user of such a top-level domain system may primarily be to give generic description of a term such as “Hotel”. Another way this top-level domain system can work is that the first term 28e “Hotel” is indexed to the unique identifier of “Hotel Hotel that provides lodging”, and that unique identifier is indexed in the search engine knowledge graph. When the unique identifier is looked up the relevant material can be obtained and formatted for display in a knowledge panel 29b. At the same time, the first term 29e “Hotel” can be indexed to a separate, or another, unique identifier (and in other examples any number of unique identifiers can be indexed to a particular term such as 29e “Hotel”. This other unique identifier could be for example the owner or joint owner, or licensee or joint licensee of the term 28e “Hotel”. Such a joint user of the term could allow the user to post the social media share or comment 29j. Such a position to share social media 29l could be to promote a particular hotel to complement the prior generic description about hotels in general. In this way the post can complement the material or content in the knowledge panel 29b, and provide a current position, and be from a first-person presentation, which can greatly help the knowledge panel 29b material 29h presented from a neutral point of view. This mix of material provides for a new social media system and method 29l.

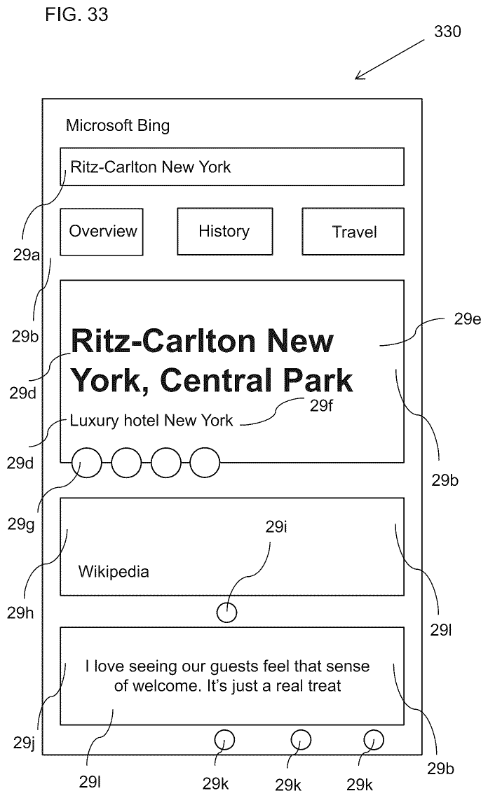

FIG. 33 shows a schematic diagram of an aspect of the invention, being a computer implemented method 330. This method 330 is in the form of a mobile phone screen and display of a search engine browser. All the applicable FIGS. 29a-29l with descriptions in FIG. 29 also apply to this FIG. 33, taking into account that in this FIG. 33 there are the following interchangeable examples where, 29a is “Ritz-Carlton New York”, and 29d is “Ritz-Carlton New York, Central Park Luxury hotel New York”, and 29e is “Ritz-Carlton New York, Central Park”, and 29f is “Luxury hotel New York”.

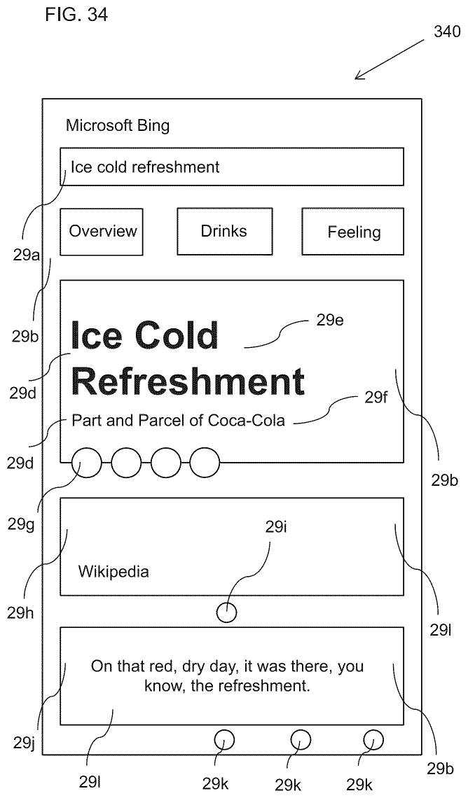

FIG. 34 shows a schematic diagram of an aspect of the invention, being a computer implemented method 340. This method 340 is in the form of a mobile phone screen and display of a search engine browser. All the applicable FIGS. 29a-29l with descriptions in FIG. 29 also apply to this FIG. 34, taking into account that in this FIG. 34 there are the following interchangeable examples where, 29a is “Ice cold refreshment”, and 29d is “Ice Cold Refreshment Part and Parcel of Coca-Cola”, and 29e is “Ice Cold Refreshment”, and 29f is “Part and Parcel of Coca-Cola”.

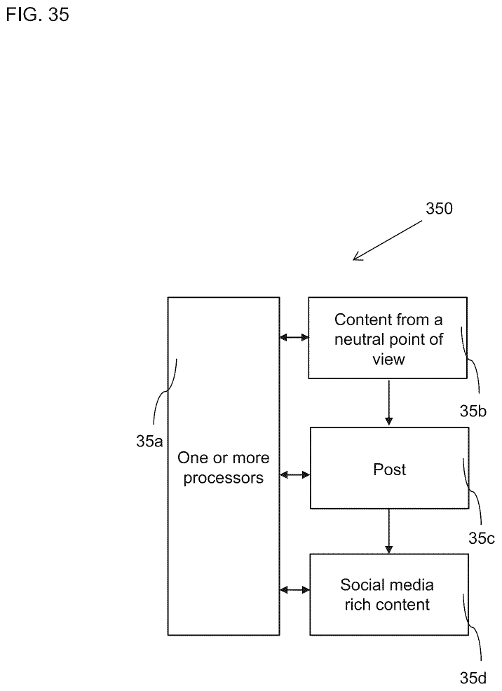

FIG. 35 shows a schematic diagram of an aspect of the invention, being a computer implemented method 350. 35a shows one or more processors. 35b shows content from a neutral point of view. 35c shows the process of a social media post. 35d shows the result of the social media content including rich content. By way of example, in this way, when a computer user connected via one or more processors 35a, inputs a search query such as “Michael Mann” into a search engine browser, the results include a list of various “Michael Mann” people with additional terms to differentiate them, noted by their second terms. Each entity represented by the term “Michael Mann” has an account with a panel domain service where they pay an annual amount for the license of their term or panel domain. When the user chooses one such person or entity, they are directed to search results including a knowledge panel that includes content from a neutral point of view 35b. Such content can be from any article, such as Wikipedia. To provide texture, diversity, relief and life, “Michael Mann” the user of the knowledge panel, inputs a social media post 35c. This can be of unverified material, such as a post about anything, or such as something complementing the knowledge panel content. Alternatively, the social media post 35c can be of verified material such as material indexed in the search engine knowledge graph. Preferably such a post 35c will be from a first-person point of view to provide texture to the neutral point of view of the Wikipedia material 35b. When a viewer sees the post, such as a video or text, as a share from “Michael Mann” the viewer feels captivated and important, as they are being spoken to directly, and in a way that unifies the whole content or material of the knowledge panel. This is the provision of social media rich content 35d. To further increase the high impact of the knowledge panel the post is verified as it is material online on another web site and indexed in the search engine knowledge graph. When a viewer clicks on the post 35c, it activates a hyperlink which directs the viewer to the source of the post. If it is a video, then to You Tube for example. If it is text, then to the reference of a quote or article form whence it came. In other examples, a quote can be obtained from a book or any other literature. The rich content of the social media 35d provides for a viewer having a good experience engaging with the material, and feeling and believing they can trust the material being presented to them. Further, they are able to trust the material not only because it appears trustworthy and authentic, but because it is verified, reliable and stable 35d. This is the process of achieving trustworthy social media rich content 35d, as a relationship between the knowledge panel user, “Michael Mann” in this case, and the viewer, in an authentic, and thoroughly supported way.

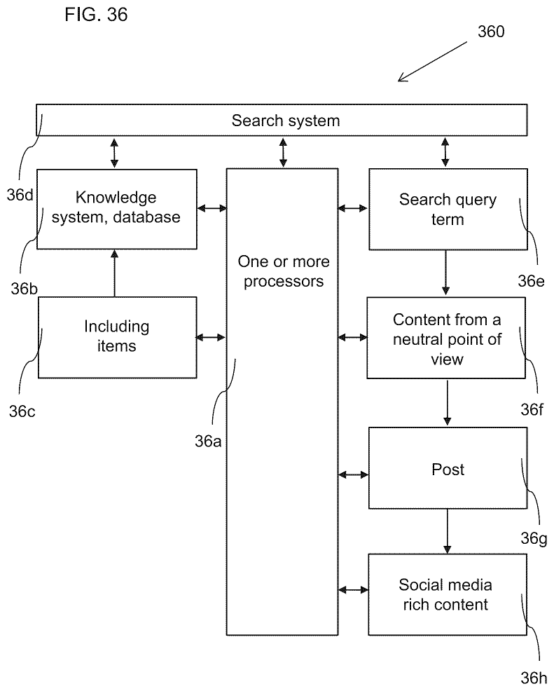

FIG. 36 shows a schematic diagram of an aspect of the invention, being a computer implemented method 360. 36a shows one or more processors. 36b shows a knowledge system or database. 36c shows the knowledge system or database includes items or entities. 36d shows a search system such as a search engine, for example Microsoft Bing, Google, or Yahoo! 36e shows a search query term. 36f shows content from a neutral point of view as part of search results, for example in a knowledge panel. 36g shows the process of a social media post. 36h shows the result of the whole social media content, including 36f content from a neutral point of view, and content 36g a post, including rich content 36h. By way of example, in this way, one or more processors 36a can include a computer user online connected to a search engine 36d, which is related to various processors and servers. The user can log onto a search engine 36d such as Microsoft Bing and do a search for “Michael Mann” 36e. The results include a list of “Michael Mann” people each further identified by further terms such as descriptions or personal preferences of each, which can be referred to the second part of the term. Each entity represented by the term “Michael Mann” has an account with a panel domain service where they pay an annual amount for the license of their term or panel domain. When the user clicks on a chosen person, they are directed to a knowledge panel that includes 36f content from a neutral point of view. This material 36f can be from Wikipedia, any article, any other encyclopedia, or anything else. To add life to the knowledge panel there is the facility for “Michael Mann” to post something 36g This post can be done anytime, and can include material that is unverified, or can include material that is verified, such as being indexed in the search engine 36d knowledge graph 36b. When the viewer sees the post 36g, which can be in any form, such as text, video, photo, or anything else, the viewer gets a first-hand perspective from “Michael Mann” of rich content 36h, and such content emphasised by the knowledge panel user when he deems it important to do so. This creates rich social media content 36h, being made up of neutral point of view material 36f and a post 36g, because they complement each other. Further, the content itself can be complementary as well as the points of view. In the case that all material is verified, the knowledge panel is raised to a very high standard of rich social media content 36h, and becomes a very trustworthy source of material. This is very different from traditional social media that provides for the posting of material that can be unverified, or untrue. The material presented from a neutral point of view is a relatively stable action or a relatively long-lasting action 36f, and the post is a current action or a relatively changeable action 36g, wherein the stable action 36f and the current action 36g combine to provide life and vitality to search results, such as including a knowledge panel 36h. A viewer could grow to anticipate the reveal of future posts 36g or upcoming posts 36g from a knowledge panel user, increasing engagement with the viewer and knowledge panel user. This new system 360 provides for viewers to obtain greater heights in understanding the knowledge panel user, “Michael Mann” in this case, and obtain a trustworthy connection directly between the knowledge panel user and the viewer, via this trusted social media system and method 36h. As a result of this trustworthy connection between the knowledge panel user and the viewer 36h, trustworthy material is shared and learned, making the user experience all round a positive one, encapsulating encouragement and remarkable virtues, including honesty, transparency, reliability, sustainability, accountability, and empathy.

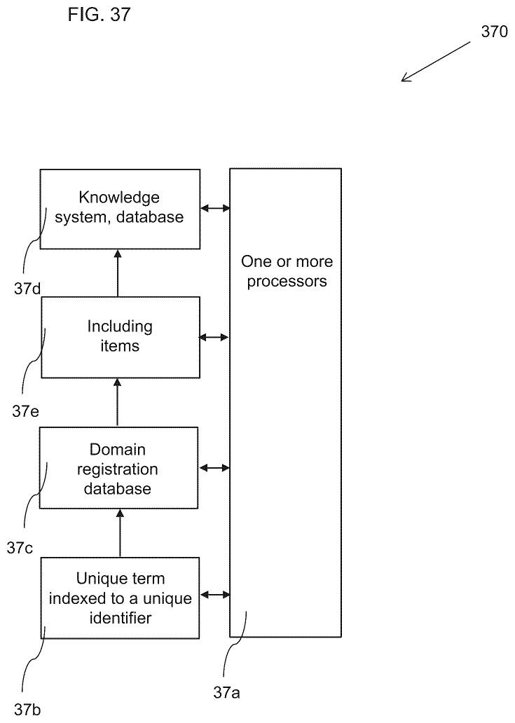

FIG. 37 shows a schematic diagram of an aspect of the invention, being a computer implemented method 370. 37a shows one or more processors. 37b shows the system and method of a unique term indexed to a unique identifier. 37c shows a domain registration database. 37d shows a knowledge system or database. 37e shows that included are items or entities. By way of example, the computer implemented method 370 will be further described. 37a can be a series of servers and computers all connected via the internet. 37b shows the system and method of a unique term such as “Google” indexed to a unique identifier such as Q-17908. A unique term means a unique term in the database 37c of any number of terms, that is, where each one is unique and different to the others. This system and method 37b can occur with any number of unique terms and unique identifiers. In this way, the unique term becomes the unique domain name address for use in a knowledge panel. This process 37b forms the content for 37c the domain registration database. This database can have any number of domain names or unique terms indexed or corresponding to respective unique identifier. This can be done via a registration service 37c where a person can log onto a web site and buy the license for one or more unique terms or unique domain names. When those purchases are made in the registration service 37c the unique term is indexed to a unique identifier of each buyer, such as at least an email address or phone number. Any other unique identifier could be used alternatively. The unique identifier in the registration service 37c is the same unique identifier in the knowledge system or database 37d. In this way, there is a look up process from either of the systems to the other and a match is made confirming that the domain name corresponds to the unique identifier in the knowledge system such as in the Google Knowledge Graph 37d. The Knowledge Graph 37d has content indexed to each unique identifier. The content indexed can be in any applicable form. 37e is items or entities that form content or are included in the Knowledge Graph 37d. Each item or entity 37e has its unique identifier in the database 37d that corresponds to the unique identifier in the domain registration service 37b. When a person does an internet search on “Google” the search engine, such as Bing, looks up “Google” in the registration service 37b and finds that “Google” has the unique identifier of Q-17908. Bing looks up the Knowledge Graph 37d and finds Q-17908. Indexed to that unique identifier is content to form a knowledge panel on the Bing browser page. Bing retrieves all that content (based on an aspirational working relationship with Google of google sharing and allowing access to its Knowledge Graph) from the database 37d and presents formatted content in a knowledge panel. Included in the knowledge panel is the domain name “Google” as the unique term 37b.

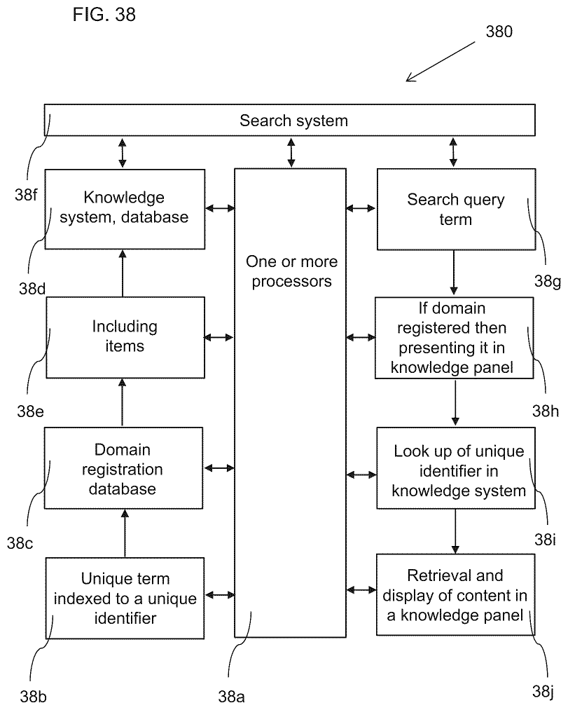

FIG. 38 shows a schematic diagram of an aspect of the invention, being a computer implemented method 380. 38a shows one or more processors. 38b shows the system and method of a unique term indexed to a unique identifier. 38c shows a domain registration database. 38d shows a knowledge system or database. 38e shows that included are items or entities. 38f shows a search system. 38g shows a search query. 38h shows process of looking up domain in the registration system 38c, and if it is registered then presenting the domain in a knowledge panel (and if it is not then not displaying any results in a knowledge panel). 38i shows process of looking up domain unique identifier in the knowledge system 38d. 38j shows process of the results of 38i, where content is retrieved that is indexed to a unique identifier and such content is formatted and displayed in a knowledge panel with the unique term or domain 38h. By way of example, the computer implemented method 380 will be further described. A computer network is connected together 38a across the internet, including various servers and machines with all applicable software to operate them. A person does a search 38g on the term “American film director”, using the search engine “Google” 38f. Google 38f looks up the term 38g in the database 38c and finds it is registered there to “John Doe”. John Doe has used his email address as “hi@ johndoeamericanfilmdirector.com” as his unique identifier when he purchased the 1 year license for his domain name (and in other embodiments any form of unique identifier could be used, although standard ones are preferred). That domain is also known as a panel domain. The processors 38s via Google 38f obtain John Doe's email address unique identifier and the domain name. Google 38f then looks up 38i in its Google Knowledge Graph 38d the unique identifier of Doe's email address. Google 38f finds the item or entity 38e indexed in the Graph 38d. Google 38f then retrieves all content 38j for the knowledge panel display, and formats that in the knowledge panel 38j for all aesthetics and design requirements and standards 38j, together with the unique term or domain or panel domain 38h. As the term “American film director” is a generic term licensed by Doe, the resulting knowledge panel is of a definition style knowledge panel about American film directors. As Doe is also an American film director, at the bottom of the “American film director” knowledge panel is a second knowledge panel with the panel domain “John Doe”. These two knowledge panels are connected by the term “American film director” (as the domain for the first knowledge panel) and as the supporting term for “John Doe’ who has the panel domain “John Doe American film director”. Integrity for the domains is kept by having the theme of a definition for a generic term like “American film director” and if an individual owns the license for such a term (and optionally are linked to that term) then they are able to have their own knowledge panel below the definition or generic style one. In this way they can be associated in a genuine way with value and integrity. The person who did the search 38g sees in their search engine browser 38f the results 38h and 38j of their search query in the form of a first knowledge panel of “American film director” and a second knowledge panel of “John Doe American film director”. In other embodiments, there may be one knowledge panel shown as a search result 38h and 38j (like the process described in FIG. 370) or any other number of knowledge panels linked together or stacked below each other 38h and 38j as one or as separate items 38h and 38j.

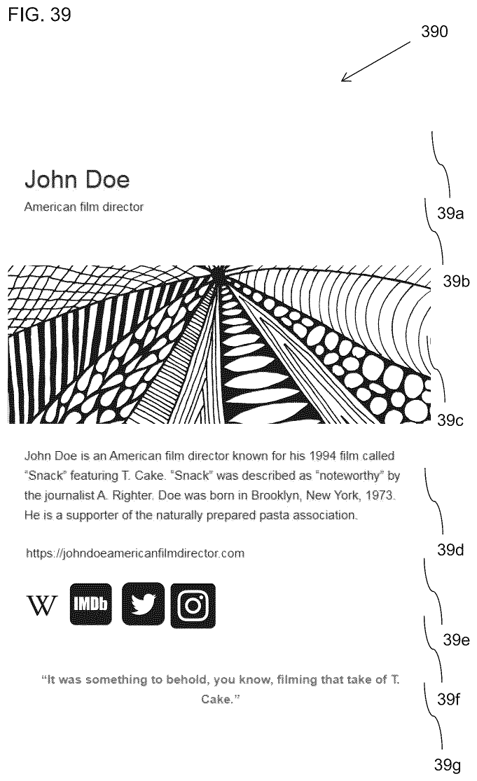

FIG. 39 shows a schematic diagram of an aspect of the invention, being a computer implemented method 390. 39a shows a boarder frame in light form. 39b shows a point of the area for the unique term or domain or panel domain. 39c shows a point of the area for an image. 39d shows a point of the area for the text description. 39e shows a point of the area for a web site or URL. 39f shows a point for the area for social media icons or resources. 39g shows a point of the area for a social media post. By way of example, the computer implemented method 390 will be further described. “John Doe” has bought a 1 year license for the panel domain “John Doe American film director”. An internet user does a search of “John Doe American film director” for example on Microsoft Bing. Bing has the unique identifier of Q-13445 indexed to “John Doe American film director” as an internal domain registration system. Bing locates the term “John Doe American film director” and its unique identifier. With the unique identifier Q-13445 it locates content including for being formatted in a knowledge panel. Bing then presents the knowledge panel content for the domain “John Doe American film director” in the search engine Bing browser as a complete knowledge panel. The format of the items making up the knowledge panel when reading from the top is: 1) 39b area for domain or panel domain 2) 39c area for image 3) 39d area for text description 4) 39e area for web site or URL 5) 39f area for social media icon or icons or resources 6) 39g social media post (such as a quote that is verified with content as true and correct already present online). In other embodiments the order of the items 1-6 can be in any chosen order. In this embodiment 390 the area for the panel domain 39b is the same as or is close to the same as the area for the image 39c. The format of the domain area 39b is landscape as is the format for the image area 39c.

For all of the figures and drawings the system and method of the inventions can include any combination or permutation of the elements and principles of design (as are known in the design industry) used for any given embodiment, or any range of embodiments.

The following paragraphs below in the quoted section are quoted from patent U.S. Pat. No. 9,268,820B2. Those paragraphs are quoted because they well describe common or public material including computing systems and related matters, that various inventions can integrate with, or that inventions can be implemented by, including the current invention, or inventions. Those paragraphs relate to patent U.S. Pat. No. 9,268,820B2, and also to the inventions herein, and so are quoted to be incorporated in full as part of this specification, as part of this invention. Those quoted paragraphs include descriptions of computing systems, and related matters, and related interpretations, as to how each invention herein is embodied or implemented in a computer implemented system, or such like, including related matters. Credit for authorship and any possible copyright for those quotes are hereby acknowledged as vesting in patent holder of patent U.S. Pat. No. 9,268,820B2, or whoever they have provided that to.

Begin quote from patent U.S. Pat. No. 9,268,820B2:

“Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (Held programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.”

End of quote from patent U.S. Pat. No. 9,268,820B2.

In yet other embodiments the system and method of any of the methods described herein, there can be of any design with applicable design specifications, structure or architecture, including with related components or parts, to be used in line with the spirit and scope of the inventions.

Since modifications within the spirit and scope of the invention may readily be affected by persons skilled within the art, it is to be understood that this invention is not limited to the particular embodiments described by way of example hereinabove.

What is claimed is:

1. A computer implemented method comprising:
one or more processors configured to perform operations including:
a method of a search query term being matched in search related material, wherein the search query term is the same term, or matched term, present in at least some of the search related material.

2. The method of claim 1, wherein the matched term is a repeat of the search query term, or the matched term is a duplication of the search query term.

3. The method of claim 1, wherein an item or entity is registered in an account system with a term such as a wording reference indexed to the item or entity, wherein the term such as a wording reference is a match to the search query term.

4. The method of claim 1, wherein the search related material includes search results, which can include at least part of the material in a knowledge panel.

5. The method of claim 1, wherein the search query term is auctioned, wherein the highest bidder wins the auction, and wherein the auction winner has the right to manage where the search term match is presented in respect of the search related material.

6. The method of claim 5, wherein the auction is in real time.

7. The method of claim 1, wherein the search query term and or matched term relates to any of: the auction winner; and or an item label, and or an entity title.

8. The method of claim 1, wherein the search query term and or matched term to that applies to any jurisdiction, which can include any geographical jurisdiction being made up of any number of places, which can include any of: a town; and or a city; and or a state; and or a country; and or more than one country; and or a continent; and or more than one continent; and or across the world.

9. A computer implemented method comprising:
one or more processors configured to perform operations including:
a method of a top-level domain system comprising at least:
a term such as a search term connected via relationship with at least a part of search related material.

10. The method of claim 9, wherein the search related material includes a term that is a fractal of the search term.

11. The method of claim 9, wherein the at least a part of search related material includes a term that is the same term or matched term as the search term, wherein the connection between the search term and search related material is created by the same term being present in both, and wherein the relationship between the terms is that the term in the search related material is a fractal of the search term.

12. A computer implemented method comprising:
one or more processors configured to perform operations including:
a method of a domain name comprising a unique term that is indexed to at least a unique identifier.

13. The method of claim 12, wherein the domain name is a unique term and wherein the unique identifier has content indexed to it, or a corresponding unique identifier in a knowledge graph has content indexed to it.

14. The method of claim 12, wherein content that is indexed to the unique identifier is any content and in any format.

15. The method of claim 12 where the domain name is registered in a registration system with at least the domain name comprising a unique term indexed to at least a unique identifier wherein the unique identifier optionally has content indexed to it, or a corresponding unique identifier in a knowledge graph has content indexed to it.

16. The method of claim 12 comprising:
one or more processors configured to perform operations including:
a method of presenting search related material comprising:
a knowledge system or database including items or entities;
a domain name registration system or database;
a search system;
a search query;
parsing a search query;
checking a domain registration database for a domain name that is a unique term;
if the domain name is registered in the database then retrieving the domain name and presenting it in a knowledge panel; and
locating the unique identifier indexed to the domain name and then locating that unique identifier in a knowledge system or database and retrieving content indexed to the unique identifier in the knowledge system or database or knowledge graph and presenting that in a knowledge panel together with the domain name; or
if the domain name is not registered in the domain name system or database then not presenting a domain name and corresponding content indexed to a unique identifier in a knowledge panel from the search query.

17. The method of claim 1, wherein any combination or permutation of the elements and principles of design (as are known in the design industry) are used for any given embodiment, or any range of embodiments.

18. The method of claim 1, where any combination or permutation of any number of claims can be made with any number of other claims, creating the definition of new claims.

19. The method of claim 1, where the system and method as represented or described in any part of this specification.

20. The method of claim 1, where the system and method as represented or described in any part of the figures or drawings.
